(19) United States
(12) Patent Application Publication
(10) Pub. No.: US 2010/0235430 A1
(43) Pub. Date: Sep. 16, 2010

(54) METHODS AND SYSTEMS TO PROVIDE SERVICES TO A MOBILE DEVICE

(76) Inventor: Bruce Kim, Honolulu, HI (US)

Correspondence Address: SCHWEGMAN, LUNDBERG & WOESSNER, P.A., P.O. BOX 2938, MINNEAPOLIS, MN, 55402, US

(21) Appl. No.: 12/404,062

(22) Filed: Mar. 13, 2009

(51) Int. Cl. G06F 15/177; G06F 15/16; H04M 3/42

(52) U.S. Cl. 709/203; 709/221; 455/414.1; 709/224; 715/700

(57) ABSTRACT

Methods and Systems to provide services to a mobile device are explained herein. A system receives a request from a supplemental service library that is embedded in a client application program in a mobile device. The supplemental service library is a standard software component that is included in the client application program. The client application program is distributed over a network and stored on the mobile device. Next the system identifies a supplemental service from multiple supplemental services based on the request. Finally, the system communicates a response to the mobile device responsive to receiving the request. Further, a system includes a stand-alone client application program that may work in conjunction with a supplemental service program or a thin client program. Finally, supplemental service interfaces are stored on a computer readable medium for execution on a mobile device in conjunction with a supplemental service library.

### FIELD

The present application relates generally to the technical field of data communications.

### BACKGROUND

Developers of application programs may distribute their application programs to users of mobile devices through third party distributors. For example, the developer may publish their application program to an application store server that, in turn, enables browsing and distribution of the application program to users of the mobile devices. Accordingly, the developer of the application and the user that acquires the application are interposed by the third party distributor.

### BRIEF DESCRIPTION OF THE DRAWINGS

The present application is illustrated by way of example and not limitation in the figures of the accompanying drawings, in which like references indicate similar elements and in which:

FIG. 1 is a network diagram depicting a prior art networked system, according to one example embodiment, having a client-server architecture;

FIG. 2 is a network diagram depicting a networked system, according to one example embodiment, having a client-server architecture;

FIG. 3A is a block diagram depicting standard software components, according to one example embodiment;

FIG. 3B is a block diagram depicting application programs, according to one example embodiment;

FIG. 4A is a block diagram illustrating a mobile device, according to an embodiment, storing a client application program;

FIG. 4B is a block diagram illustrating a mobile device, according to an embodiment, storing a stand-alone client application program;

FIG. 4C is a block diagram illustrating a mobile device, according to an embodiment, storing a stand-alone client application program;

FIG. 5 is a block diagram illustrating multiple channels of communication, according to an embodiment, to communicate with a supplemental service server.

FIG. 6 is a block diagram illustrating a supplemental service library, according to an embodiment;

FIG. 7 is a block diagram illustrating a supplemental service server, according to an embodiment;

FIG. 8 is a block diagram illustrating supplemental services, according to an embodiment;

FIG. 9 is a block diagram illustrating a data storage device, according to an embodiment;

FIG. 10 is a block diagram illustrating mobile device information, according to an embodiment;

FIG. 11 is a block diagram illustrating administrator information, according to an embodiment;

FIG. 12 is a block diagram illustrating a request, according to an embodiment;

FIG. 13 is a block diagram illustrating a response, according to an embodiment;

FIG. 14 is a block diagram illustrating a build, according to an embodiment, of a client application program.

FIG. 15 is a block diagram illustrating a build, according to an embodiment, of a supplemental service program;

FIG. 16 is a block diagram illustrating a build, according to an embodiment, of a thin client program;

FIG. 17 is a flow chart illustrating a method, according to an embodiment, to provide supplementary service to a mobile device;

FIG. 18 is a flow chart illustrating a method, according to an embodiment, to provide a supplementary service to a mobile device;

FIG. 19 is a flow chart illustrating a method, according to an embodiment, to communicate a notice to a mobile device;

FIG. 20 is a flow chart illustrating a method, according to an embodiment, to receive and store an advertisement;

FIG. 21 is a flow chart illustrating a method, according to an embodiment, to capture diagnostic information;

FIG. 22 is a flow chart illustrating a method, according to an embodiment, to report diagnostic information;

FIG. 23 is a flow chart illustrating a method, according to an embodiment, to generate a user interface that identifies active and inactive users of a client application program;

FIGS. 24-36 are diagrams illustrating user interfaces, according to an embodiment; and

FIG. 37 is a block diagram of a machine, according to an example embodiment, including instructions to perform any one or more of the methodologies described herein.

### DETAILED DESCRIPTION

Methods and systems to provide services to a mobile device are described. In the following description, for purposes of explanation, numerous specific details are set forth in order to provide a thorough understanding of the present application. It will be evident, however, to one skilled in the art that the present application may be practiced without these specific details.

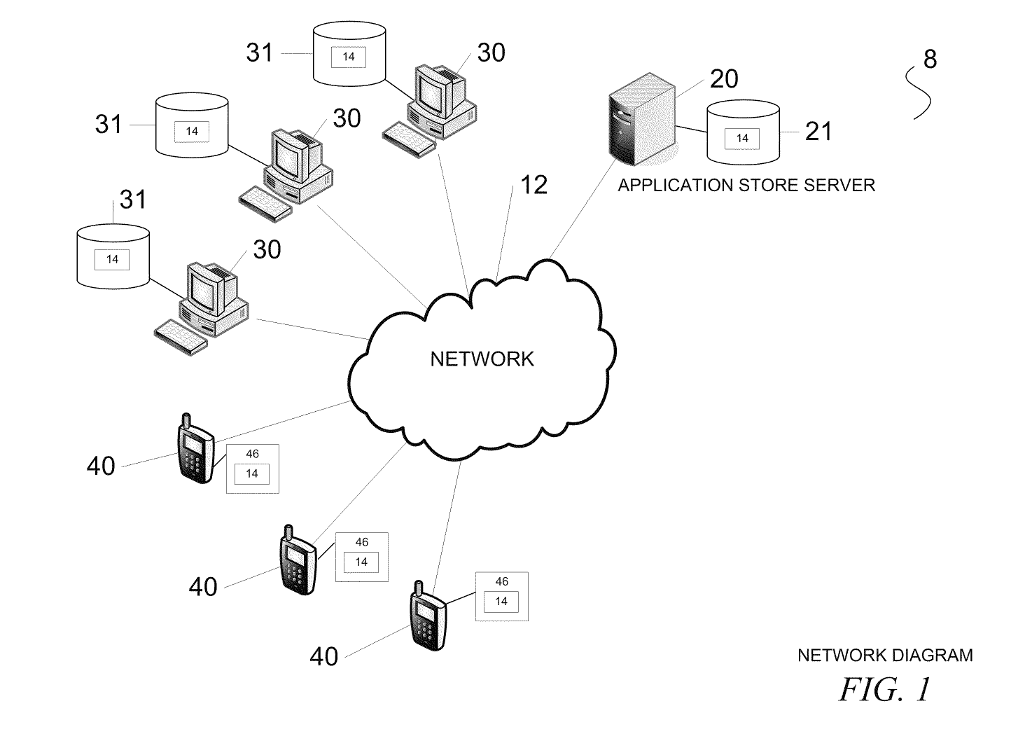

FIG. 1 is a network diagram depicting a system 8, according to one embodiment, having a client-server architecture. The system 8 includes an application store server 20, administrative computer systems 30, and mobile devices 40. The application store server 20 may communicate over a network 12 with the one or more mobile devices 40 and the one or more administrative computer systems 30.

The application store server 20 may be coupled to a data storage device 21 that stores an application program 14. For example, the application program 14 may include an arcade game application, a movie listings application, an expense tracker application or some other application. In addition, the administrative computer systems 30 may be respectively coupled to a data storage device 31 that also stores the application program 14. Further, the mobile devices 40 may respectively include a data storage device 46 that stores the application program 14.

Broadly, an administrative computer system 30 may publish the application program 14 over the network 12 to the application store server 20 that, in turn, may present the application program 14 for browsing by the users of the one or more mobile devices 40 and for distribution to the one or more mobile devices 40. For example, the application store server 20 may communicate the application program 14 to a particular mobile device 40 in response to a request from a user of the mobile device 40. The request may further include a payment for the application program 14.

One challenge associated with the above described system 8 occurs when a user of a mobile device 40 requires a service related to the application program 14 that is resident on the mobile device 40. For example, a user looking for help associated with the application program 14 may open a browser window, access a search engine to locate the appropriate administrative computer system 30, and access the administrative computer system 30 for the desired help. In other words, a context switch is performed by the user to obtain the help. Such a switch may be considered a barrier from the point of view of the user. Yet another challenge may be presented to the developer, distributor, or administrator of the application program 14 who operates the administrative computer system 30. Specifically, the operator may be hindered in establishing a commercial relationship with the user of the mobile device 40 unless the user initiates contact with the administrative computer system 30.

According to a first aspect of the present disclosure a method and system to provide supplementary service to a mobile device is disclosed. A supplemental service server may receive a request from a supplementary service library that is embedded in a client application program that executes on a mobile device. The supplementary service library may be utilized by the mobile device to provide supplementary services for the mobile device. The supplementary services may for example include a help service, a user profile service, a social networking service, a blogging service and other services. In response to the request, the supplemental service server may identify a supplemental service from multiple supplementary services. For example, the supplementary service server may utilize the request to identify the social networking service. Finally, the supplemental service server may communicate a response to the mobile device that provides the requested service.

According to a second aspect of the present disclosure another method and system to provide supplementary service to a mobile device is disclosed. A supplemental service server may receive a request from a supplemental service library that receives the request from a stand-alone client application program in a mobile device. According to a first embodiment of the second aspect, the supplemental service library may be built into a supplemental service program that is communicatively coupled to the stand-alone client application program. According to a second embodiment of the second aspect, the supplemental service library may be built into a thin client program that is communicatively coupled to the stand-alone client application program.

According to a third aspect of the present disclosure, multiple supplemental service interfaces are disclosed. The multiple supplemental service interfaces may be stored on a computer readable medium for execution on a mobile device in conjunction with the above described supplemental service library. For example, the supplemental service interfaces may provide the client application program with access to modules that are included in the supplemental service library. The supplemental service interfaces may include a first interface in the form of a request module that receives a request from the client application program, a second interface in the form of a user interface module that communicates the request to the supplemental service server. The request may include a mobile device identifier that identifies the mobile device from the other mobile devices and a client application program identifier that identifies the client application program from other client application programs that are serviced by the supplemental service server. In addition to the previously mentioned interfaces, the supplemental service interfaces may further include a third interface in the form of a mobile device module, a fourth interface in the form of a diagnostic module, a fifth interface in the form of a notice forwarding module, a sixth interface in the form of a request forwarding module and a seventh interface in the form of a response forwarding module as described further below.

### Platform Architecture

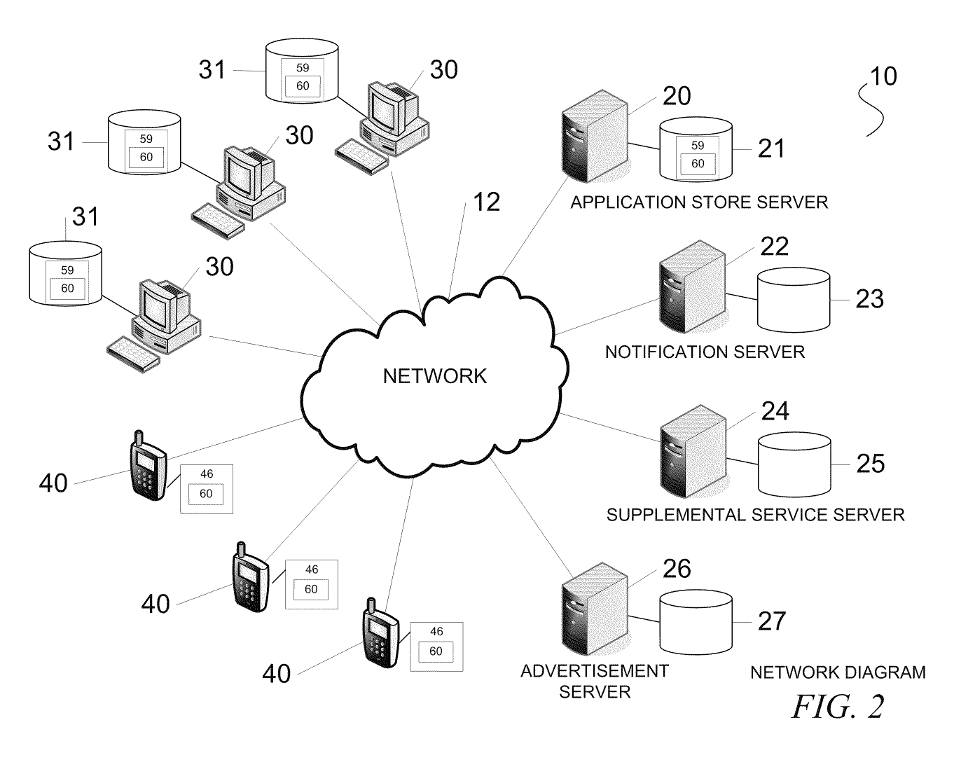

FIG. 2 is a network diagram depicting a system 10, according to one embodiment, having a client-server architecture. The system 10 includes an application store server 20, a notification server 22, a supplemental service server 24, an advertisement server 26, administrative computer systems 30, and mobile devices 40. The application store server 20 may communicate over a network 12 with the one or more mobile devices 40 and the one or more administrative computer systems 30, as previously described.

The application store server 20 may be coupled to a data storage device 21 that stores an application program in the form of a client application program 60. For example, the client application program 60 may include an arcade game application, a movie listings application, an expense tracker application, or some other application. In addition, the administrative computer systems 30 may be respectively coupled to a data storage device 31 that also stores one or more client application programs 60. Further, the mobile devices 40 may be respectively coupled to a data storage device 46 that stores one or more client application programs 60.

Broadly, the administrative computer system 30 may be operated by a developer, distributor, or administrator of client application programs 60 who may build the client application programs 60 with a standard software component in the form of an embedded supplemental service library and publish the client application program 60 to the application store server 20. The application store server 20 may present the client application program 60 for browsing and for distribution (sale, license, free, etc.) to the mobile devices 40. Accordingly, a user of a mobile device 40 may request a client application program 60 from the application store server 20 and further receive the embedded supplemental service library. Further, a user of a mobile device 40 may request supplemental service via the embedded supplemental service library without a context switch, as previously described. Merely for example, the user may request a social networking service without opening a browser window.

The mobile device 40 may include a smart phone, a cell phone, a personal digital assistant or any other device adapted for mobility and enabled to communicate via the network 12. For example, the mobile device 40 may be embodied as the Blackberry™ wireless hand held business or smart phone manufactured by Research In Motion of Waterloo, Ontario. The mobile device 40 includes a storage device 46 that stores the client application program 60.

The network 12 may include the Internet, a wireless network, a local area network, a wide area network, a Plain Old Telephone System (POTS) base network, a Code Divisional Multiple Access (CDMA) type network, a Global System for Mobile (GSM) communications based network, or some other suitable network or technology for communicating on the network 12.

The administrative computer system 30 may be utilized to build the client application program 60 with the supplemental service library and to distribute the client application program 60 to the application store server 20. In other embodiments, the administrative computer system 30 may be utilized to build and distribute other application programs 59 as described further below. The administrative computer system 30 may further be utilized to communicate with supplemental service server 24 to assist in the provision of services to the mobile devices 40.

The application store server 20 may receive, store, and distribute the client application program 60. For example, in one embodiment the application store server 20 may receive over the network 12 the client application program 60, as previously described. In other embodiments, the application store server 20 may be utilized to distribute other application programs 59 as described further below. Further, the application store server 20 may enable browsing of the application programs 59 and distribution of the application programs 59 to the mobile devices 40. For example, the application store server 20 may communicate one or more of the application programs 59 to a mobile device 40 in response to a request from the mobile device 40. Merely for example the application store server 20 may be embodied as the “App Store” created by Apple Computers, Inc. of Mountain View Calif., a system that enables users of the mobile devices 40 and other devices to browse and retrieve inter alia application programs that may be published by developers, distributors, or administrators of the application programs.

The supplemental service server 24 may receive a request from a supplemental service module that is included in a supplemental service library, identify a requested supplemental service, and communicate a response to a mobile device 40 in response to the received request. For example, a response may include information to display a user interface that is utilized to provide a supplemental service to the mobile device 40. In one embodiment the supplemental services may include a home service, a messaging service, a blogging service, a user profile service, a social networking service, a user settings service, a notification service, a diagnostic service, an advertisement analysis service, and other services. Further, the supplemental service server 24 may communicate or push notices via the notification server 22 to a mobile device 40. Further, the supplemental service server 24 may retrieve an advertisement from the advertisement server 26, store the advertisement on the data storage device 25, and communicate the advertisement to the mobile devices 40. In another embodiment the supplemental service server 24 may communicate advertisement retrieval information to the mobile device 40 that, in turn, retrieves the advertisement from the advertisement server 26.

The notification server 22 may communicate notices to the mobile device 40. In one embodiment, the notification server 22 may receive the notice and push the notice to the mobile device 40. For example, the notification server 22 may receive the notice from the supplemental service server 24 and communicate the notice to the mobile device 40 without a prior request from the mobile device 40. The notification server 22 may further be coupled to a data storage device 23 that stores notices.

The advertisement server 26 may store advertisements on a data storage device 27 and communicate the advertisements to the supplemental service server 24 that, in turn, communicates the advertisements to the mobile device 40. In another embodiment the advertisement server 26 may communicate the advertisements directly to the mobile device 40.

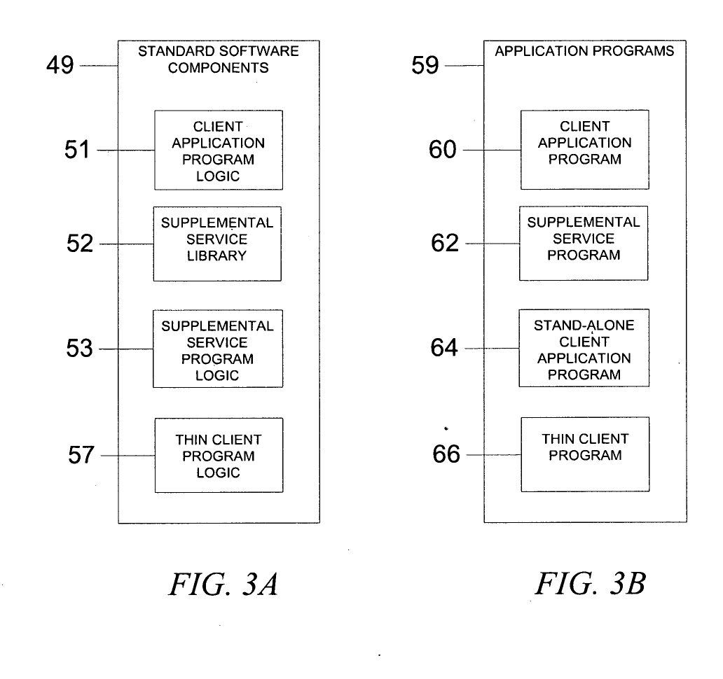

FIG. 3A is a block diagram depicting standard software components 49, according to one example embodiment. The standard software components 49 may be used to build application programs 59. The standard software components 49 include client application program logic 51, a supplemental service library 52, supplemental service program logic 53, and thin client program logic 57, as described further below.

FIG. 3B is a block diagram depicting application programs 59, according to one example embodiment. The application programs 59 may be built with the standard software components 49. The application programs 59 may include a client application program 60, a supplemental service program 62, a stand-alone client application program 64, and a thin client program 66, as described further below.

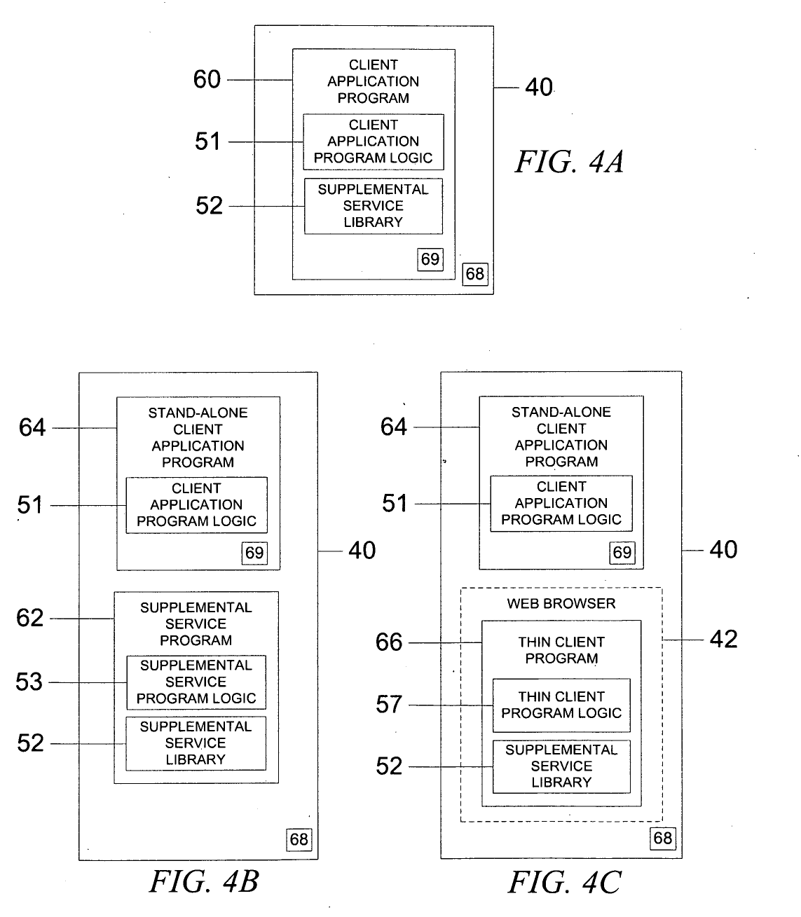

FIG. 4A is a block diagram illustrating a mobile device 40, according to an embodiment, storing a client application program 60. The mobile device 40 may include a mobile device identifier 68 that is utilized to identify the mobile device 40 from other mobile devices 40 on the network 12. The client application program 60 may include client application program logic 51 and a supplemental service library 52 that is embedded in the client application program 60. Accordingly, the client application program logic 51 is linked to the supplemental service library 52 and may directly invoke the supplemental service library 52 to request a supplementary service. The client application program 60 may further include a client application program identifier 69 that is used to identify the client application program 60 from other client application programs 60. In one embodiment, the client application program logic 51 may communicate the client application program identifier 69 to the supplemental service library 52. In one embodiment the supplemental service library 52 may read the mobile device identifier 68.

FIG. 4B is a block diagram illustrating a mobile device 40, according to an embodiment, storing a stand-alone client application program 64 and a supplemental service program 62. The mobile device 40 includes a mobile device identifier 68 as previously described. The stand-alone client application program 64 may include client application program logic 51. The client application program logic 51 may communicate a request for supplementary service to the supplemental service program 62. The supplemental service program 62 may include supplemental service program logic 53 that receives the request and invokes the supplemental service library 52. Accordingly, the supplemental service program logic 53 may externally expose the supplemental service library 52 to the client application program logic 51. The stand-alone client application program 64 may further include a client application program identifier 69 and communicate the client application program identifier 69 as previously described. In one embodiment the supplemental service library 52 may read the mobile device identifier 68.

FIG. 4C is a block diagram illustrating a mobile device 40, according to an embodiment, storing a stand-alone client application program 64 and a thin client program 66. The mobile device 40 includes a mobile device identifier 68 as previously described. The client application program logic 51 may communicate a request to the thin client program 66 for supplementary service. The thin client program 66 may include thin client program logic 57 and a supplemental service library 52. The thin client program logic 57 may externally expose the supplemental service library 52 to the client application program logic 51. In one embodiment the thin client program 66 may execute under a web browser. In another embodiment, the thin client program 66 may be communicated to the mobile device 40 via a web browser and execute independent of the web browser. The stand-alone client application program 64 may further include a client application program identifier 69 and communicate the client application program identifier 69 as previously described. In one embodiment the client application program logic 51 may read the mobile device identifier 68 from the mobile device 40 and communicate the mobile device identifier 68 to the thin client program logic 57.

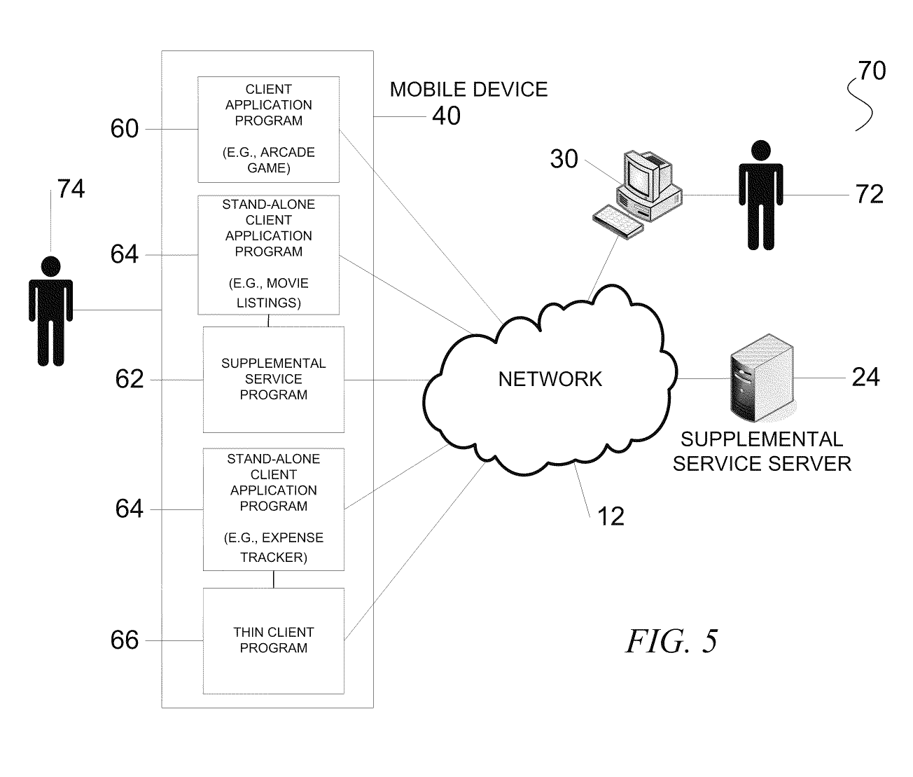

FIG. 5 is a block diagram illustrating multiple channels of communication 70, according to an embodiment, to communicate over a network 12 with a supplemental service server 24. One or more channels of communication 70 may be established from a mobile device 40 that is operated by a user 74 or from an administrative computer system 30 that is operated by an administrator 72. For example, the multiple channels of communication 70 may include channels of communication that may be respectively established via a client application program 60, a stand-alone client application program 64 that executes in conjunction with a supplemental service program 62, the supplemental service program 62, a stand-alone client application program 64 that executes in conjunction with a thin client program 66, and the thin client program 66. Accordingly, the multiple channels of communication 70 may enhance communication capabilities. For example, the user 74 may be operating the client application program 60 in the form of an arcade game and communicate a request for information about the arcade game to the supplemental service server 24. The user 74 may subsequently exit the arcade game and execute the stand-alone client application program 64 in the form of an expense tracker and receive the response to the request for information about the arcade game. In yet another embodiment, the multiple channels of communication 70 may enhance communication capabilities with respect to system messages. For example, the supplemental service server 24 may communicate a notice in the form of a message that includes an announcement about the arcade game. Continuing with the example, the message may be received and processed at the mobile device 40 while the user 74 is operating the expense tracker.

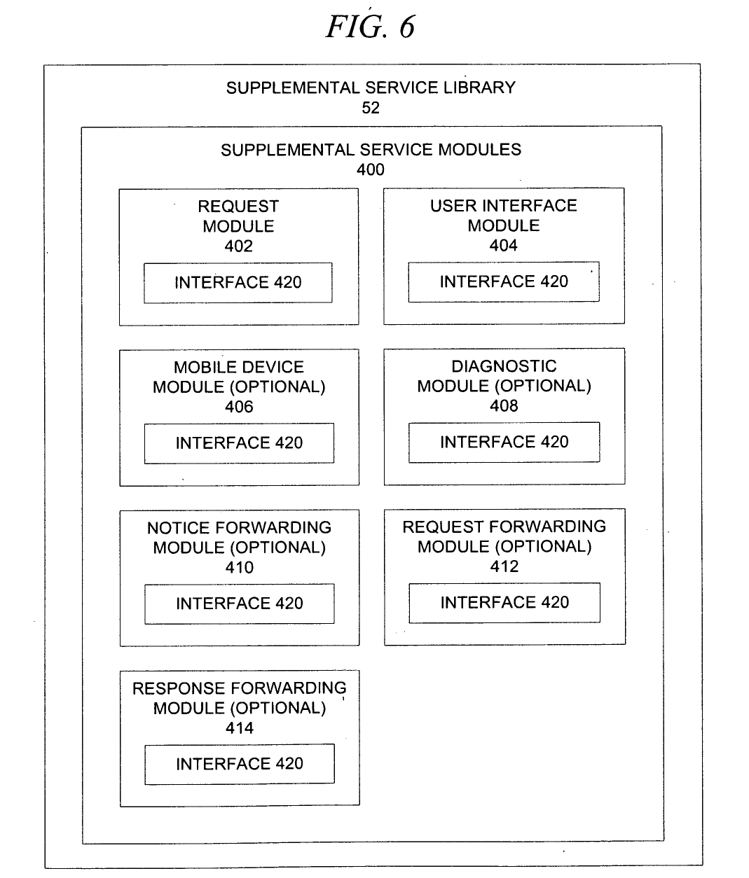

FIG. 6 is a block diagram illustrating a supplemental service library 52, according to an embodiment. The supplemental service library 52 includes supplemental service modules 400. The supplemental service modules 400 may include a request module 402, a user interface module 404, and the optional mobile device module 406, diagnostic module 408, notice forwarding module 410, request forwarding module 412, and response forwarding module 414. The supplemental service modules 400 are shown to include interfaces 420 that may be utilized to invoke the respective module. The request module 402 may receive a request from the client application program logic 51. The user interface module 404 may communicate the request to a supplemental service server 24, receive a response, and update the display on the mobile device with a user interface. The user interface module 404 may further receive and process a user action request entered from a user interface that provides a supplemental service. In one embodiment, the mobile device module 406 may read the mobile device identifier 68 from the mobile device 40 and append the mobile device identifier 68 to the request. The diagnostic module 408 may capture diagnostic information at the mobile device 40 and communicate the diagnostic information to the supplemental service server 24. The notice forwarding module 410 may receive a notice from the notification server 22 and communicate the notice to the user interface module 404 for display on the mobile device 40. The request forwarding module 412 may receive a request from the client application program logic 51 and forward the request to the supplemental service server 24. In response, the supplemental service server 24 may communicate a response that, in turn, is received by the response forwarding module 414 that forwards the response to the client application program logic 51.

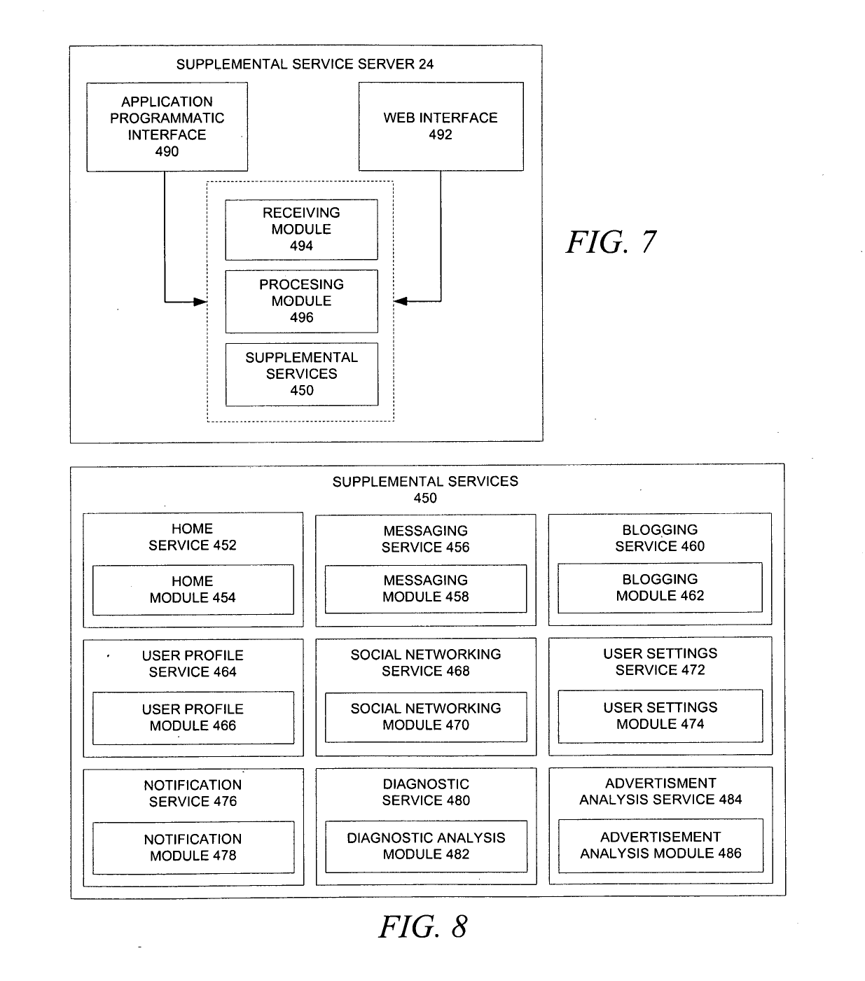

FIG. 7 is a block diagram illustrating a supplemental service server 24, according to an embodiment. The supplemental service server 24 is shown to include an application programmatic interface 490, a web interface 492, a receiving module 494, a processing module 496, and supplemental services 450. The application programmatic interface (API) 490 and the web interface 492 are coupled to, and may provide programmatic and web interfaces respectively to, the receiving module 494, the processing module 496, or the supplemental services 450. The receiving module 494 may receive requests from network entities. For example, the network entities may include the mobile devices 40, the administrative computer systems 30, the application store server 20, the notification server 22, the advertisement server 26, etc. The processing module 496 may process the request by identifying and invoking the appropriate supplemental service based on the request and communicating a response to the appropriate network entity. The supplemental services 450 include multiple and varied services that are provided to users of the mobile devices 40.

FIG. 8 is a block diagram illustrating supplemental services 450, according to an embodiment. The supplemental services 450 include a home service 452 associated with a home module 454, a messaging service 456 associated with a messaging module 458, a blogging service 460 associated with a blogging module 462, a user profile service 464 associated with a user profile module 466, a social networking service 468 associated with a social networking module 470, a user settings service 472 associated with a user settings module 474, a notification service 476 associated with a notification module 478, a diagnostic service 480 associated with a diagnostic analysis module 482, an advertisement analysis service 484 associated with an advertisement analysis module 486. The home service 452 may utilize the home module 454 to provide entry into the various supplemental services 450. The messaging service 456 may utilize the messaging module 458 to provide messaging services for the network entities that access the supplemental service server 24. The blogging service 460 may utilize the blogging module 462 to provide blogging services for users of the mobile devices 40. For example, the blogging module 462 may provide search access to various blogs that are accessible via the network 12. The user profile service 464 may utilize the user profile module 466 to provide user profile services for the users associated with the mobile devices 40. For example, the user profile services may present a picture of a user and user information. The social networking service 468 may utilize the social networking module 470 to provide social networking services such as the establishment of a friend relationship between the users of mobile devices 40. The user settings service 472 may utilize the user settings module 474 to provide user settings services. For example, the user settings services may enable the user of a mobile device 40 to configure the client application program 60 or the stand-alone client application program 64 on the mobile device 40. The notification service 476 may utilize the notification module 478 to communicate a notice to one or more mobile devices 40. For example, the supplemental service server 24 may utilize the notification service 476 to multicast a notice to users of mobile devices 40 associated with a particular client application program 60 or stand-alone client application program 64. The diagnostic service 480 may utilize the diagnostic analysis module 482 to store and make accessible diagnostic information that is captured at the mobile device 40. The advertisement analysis service 484 may utilize the advertisement analysis module 486 to analyze information associated with a user of a mobile device 40 and recommend advertisements based on the information. For example, the user may exhibit interest in various blogs or topics that is represented in information that the advertisement analysis module 486 may analyze to recommend advertisements.

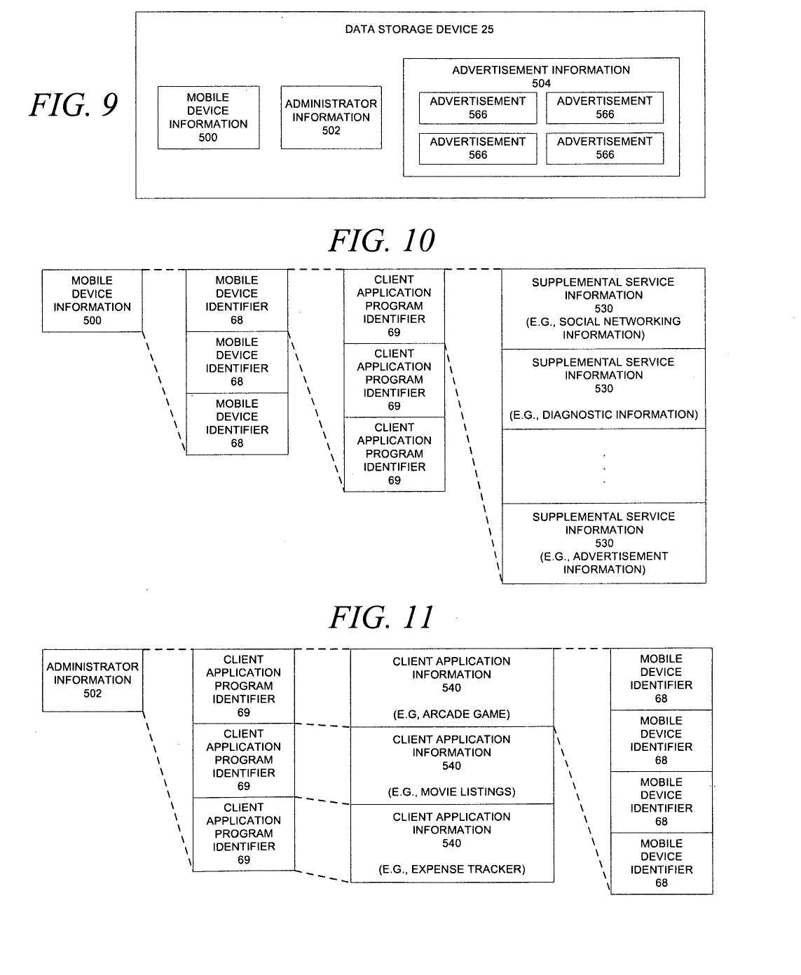

FIG. 9 is a block diagram illustrating a data storage device 25, according to an embodiment. The data storage device 25 may be coupled to the supplemental service server 24. The data storage device 25 may store mobile device information 500 for mobile devices 40 that are registered to utilize the supplemental service server 24, administrator information 502 for administrative computer systems 30 that that are registered to utilize the supplemental service server 24, and advertisement information 504 that may include advertisements 566.

FIG. 10 is a block diagram illustrating mobile device information 500, according to an embodiment. The mobile device information 500 may be utilized by the supplemental service server 24 to store information for the mobile devices 40. The mobile device information 500 may include mobile device identifiers 68, as previously described. Each mobile device identifier 68 may be associated with one or more client application program identifiers 69 that identify client application programs 60 or stand-alone client application programs 64 that are utilized by the designated mobile device 40. Each client application program identifier 69 may be associated with multiple entries of supplemental service information 530 that corresponds to the previously described supplemental services 450. For example, the supplemental service information 530 for the social networking service 468 may store the “friends” of a user. A user may be designated a “friend” of the user by accepting an invitation from the user or by sending a request to the user who subsequently grants the request. In one embodiment, the supplemental service information 530 for the social networking service 468 may further store a status for each of the friends of the user. For example, the status may indicate whether the friend is actively or not actively using the corresponding client application program 60 or stand-alone client application program 64. In like manner, other supplemental service information 530 may be stored for each of the supplemental services 450.

FIG. 11 is a block diagram illustrating administrator information 502, according to an embodiment. The administrator information 502 may include one or more client application program identifiers 69 that identify the client application programs 60 or the stand-alone client application programs 64 that are published by the administrative computer system 30 to the application store server 20. Each client application program identifier 69 may further be associated with a client application information 540 entry that may be utilized to store information about the client application program 60 or the stand-alone client application program 64. Each client application information 540 entry may further be associated with one or more mobile device identifiers 68 for the mobile devices 40 that host the corresponding client application program 60 or stand-alone client application program 64.

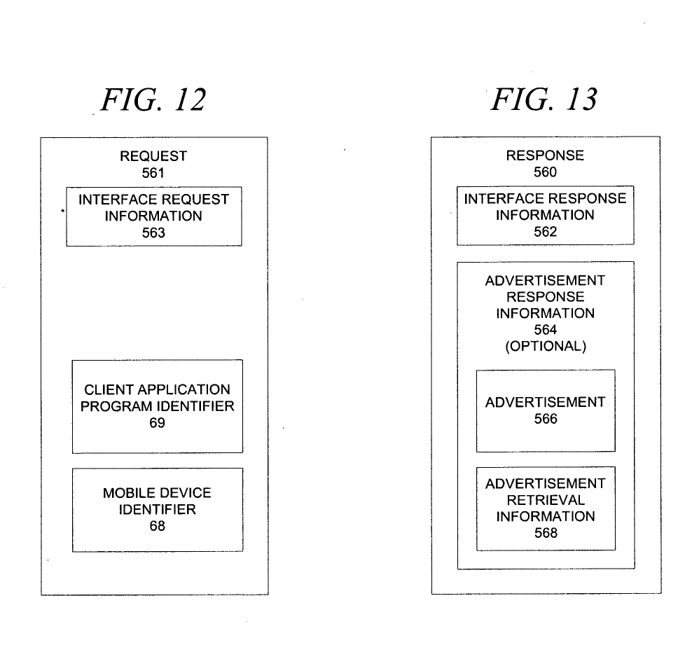

FIG. 12 is a block diagram illustrating a request 561, according to an embodiment. The request 561 may be received by the supplemental service server 24. The request 561 may include interface request information 563, a client application program identifier 69, and a mobile device identifier 68, as previously described. The interface request information 563 may include information communicated from a supplemental service module 400 in a supplemental service library 52. The client application program identifier 69 may identify the client application program 60 or the stand-alone client application program 64 that originated the request 561. The mobile device identifier 68 may identify the mobile device that originated the request 561.

In one embodiment the client application program identifier 69 may be appended to the request 561 by the client application program 60 or the stand-alone client application program 64. For example, the client application program 60 or the stand-alone client application program 64 may append the client application program identifier 69 to the request 561 and communicate the request 561 to the supplemental service library 52. The supplemental service library 52 may, in turn, append the mobile device identifier 68 to the request 561 and communicate the request 561 to the supplemental service server 24. In contrast to the above, the request 561 may also originate with the supplemental service library 52. In such instances the supplemental service library 52 may append the client application program identifier 69 and the mobile device identifier 68 to the request 561 and communicate the request 561 to the supplemental service server 24. For example, the supplemental service library 52 may have received the client application program identifier 69 in a prior request 561.

In another embodiment the client application program identifier 69 and the mobile device identifier 68 may be appended to the request 561 by the stand-alone client application program 64. For example, the stand-alone client application program 64 may append the client application program identifier 69 and the mobile device identifier 68 to the request 561 and communicate the request 561 to the thin client program 66. The thin client program 66 may, in turn, communicate the request 561 to the supplemental service server 24.

FIG. 13 is a block diagram illustrating a response 560, according to an embodiment. The response 560 may be communicated from the supplemental service server 24 to the mobile device 40. The response 560 may include interface response information 562 and advertisement response information 564 that is optional. For example, the interface response information 562 may include information to display a user interface on the mobile device 40. The advertisement response information 564 is optional and may include one or more advertisements 566 for display on the mobile device 40 and advertisement retrieval information 568. The advertisement retrieval information 568 may enable the supplemental service library 52 to retrieve one or more advertisements 566 from the advertisement server 26 for display on the mobile device 40.

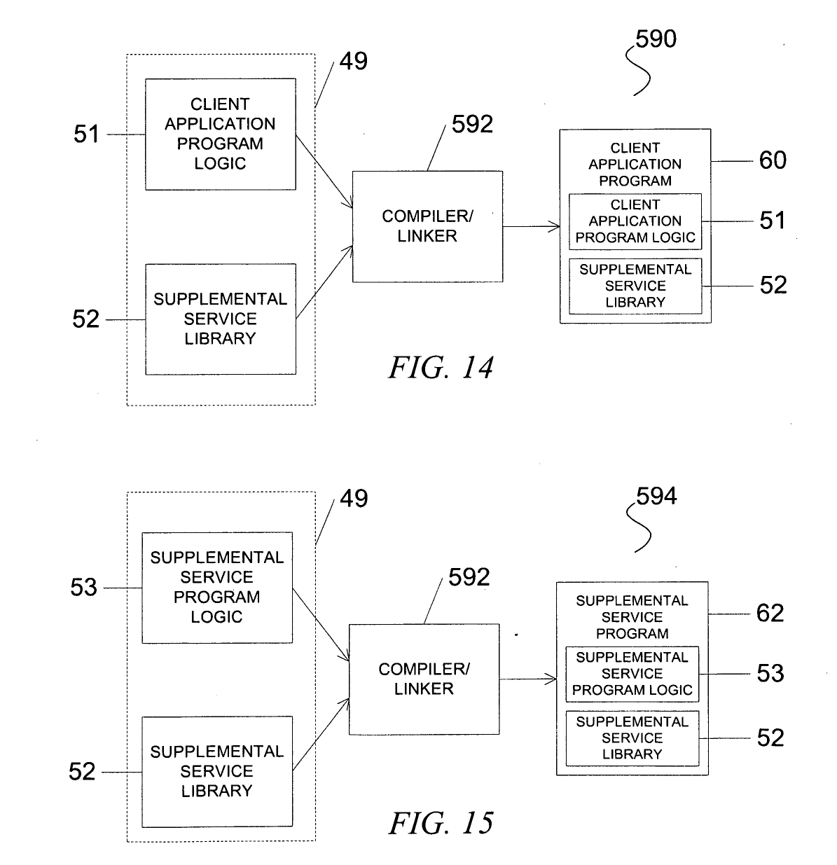

FIG. 14 is a block diagram illustrating a build 590, according to an embodiment, of a client application program 60. The build 590 includes client application program logic 51 and a supplemental service library 52 that are received as standard software components 49 into a compiler linker 592. The compiler linker 592 generates a client application program 60 that includes client application program logic 51 and the supplemental service library 52. In one embodiment the above described build 590 may be executed on the administrative computer system 30.

FIG. 15 is a block diagram illustrating a build 594, according to an embodiment, of a supplemental service program 62. The build 594 includes supplemental service program logic 53 and a supplemental service library 52 that are received as standard software components 49 into a compiler linker 592. Compiler linker 592 generates a supplemental service program 62 that includes supplemental service program logic 53 and the supplemental service library 52. In one embodiment, the above described build 594 may be executed on the administrative computer system 30.

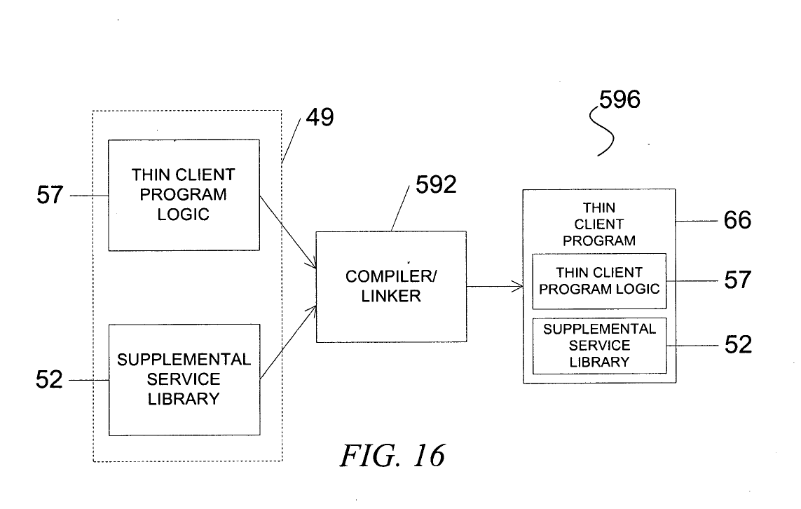

FIG. 16 is a block diagram illustrating a build 596, according to an embodiment, of a thin client program 66. The build 596 includes thin client program logic 57 and a supplemental service library 52 that are received as standard software components 49 into a compiler linker 592. Compiler linker 592 generates a thin client program 66 that includes the thin client program logic 57 and the supplemental service library 52. In one embodiment the above described build 596 may be executed on the administrative computer system 30.

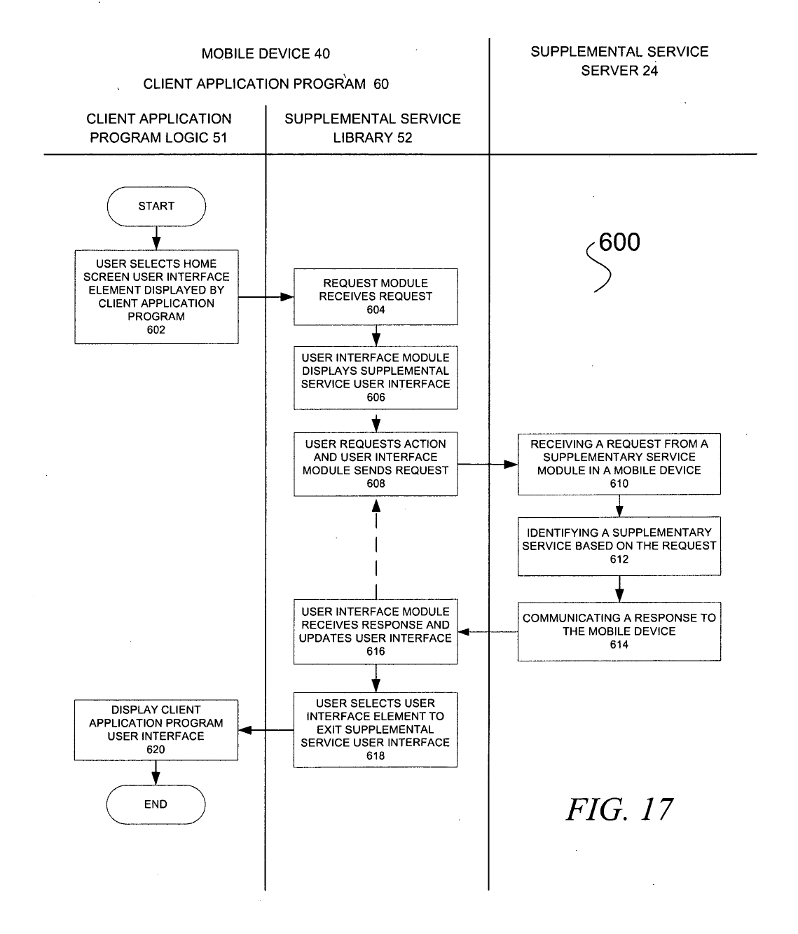

FIG. 17 is a flow chart illustrating a method 600, according to an embodiment, to provide supplementary service to a mobile device 40. Illustrated on the left are operations performed on the mobile device 40 and illustrated on the right are operations performed on the supplemental service server 24. With respect to the mobile device 40, the operations are further identified as being performed by client application program logic 51 or a supplemental service library 52. The method 600 commences at operation 602 with the user selecting a home screen user interface element that is displayed by the client application program 60. For example, the home screen user interface element may enable access to supplemental services by a user of the client application program 60.

At operation 604, at the supplemental service library 52 on the mobile device 40, the request module 402 receives the request 561. At operation 606 the user interface module 404 may display a user interface generated by the supplemental service library 52. At operation 608, the user who is operating the mobile device 40 may request further action. For example, the request for action may be received by the user interface module 404 that, in turn, communicates the request 561 to the supplemental service server 24.

At operation 610, at the supplemental service server 24, the receiving module 494 receives the request 561. At operation 612, the processing module 496 identifies a supplemental service 450 based on the request 561 and communicates the request 561 to the appropriate module that provides the identified supplemental service 450. For example, the processing module 496 may identify that the social networking service 468 is requested and invoke the social networking module 470. At operation 614, the processing module 496 may communicate a response 560 to the mobile device 40. Further, the modules 494, 496, 450 and interfaces 490, 492 at the supplemental service server 24 may use the client application program identifier 69 in the request 561 to identify the client application program 60 or the stand-alone client application program 64 that originated the request 561. Similarly, the modules 494, 496, 450 and interfaces 490, 492 at the supplemental service server 24 may use the mobile device identifier 68 in the request 561 to identify the mobile device 40 that originated the request 561 and automatically identify a user of the mobile device 40.

At operation 616, at the supplemental service library 52 on the mobile device 40, the user interface module 404 receives the response 560 and updates the display on the mobile device 40 with a user interface. The hyphenated line connecting operations 616 and 608 represents further actions that are received by the user interface module 404 and processed by the supplemental service server 24. At operation 618, the user may select a user interface element to cause an exit from the most recent user interface displayed by the supplemental service library 52.

At operation 620, at the mobile device 40, the client application program logic 51 displays a user interface that is generated by the client application program 60 and ends.

In another embodiment, the above described method 600 may be performed by a stand-alone client application program 64 in conjunction with a supplemental service program 62. In yet another embodiment, the above described method 600 may be performed by a stand-alone client application program 64 in conjunction with a thin client program 66.

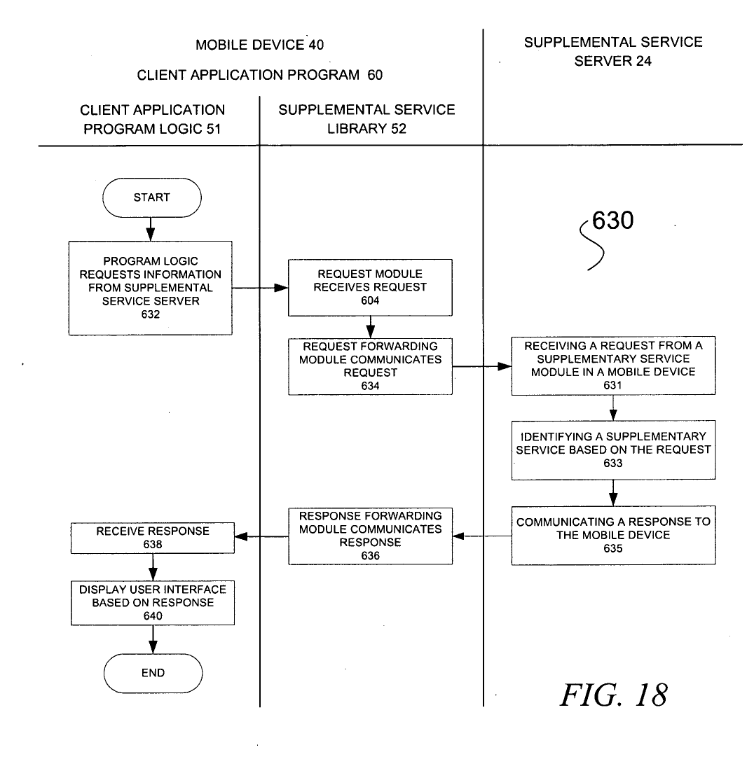

FIG. 18 is a flow chart illustrating a method 630, according to an embodiment, to provide a supplementary service to a mobile device 40. Illustrated on the left are operations performed on the mobile device 40 and illustrated on the right are operations performed on the supplemental service server 24. With respect to the mobile device 40, the operations are further identified as being performed by client application program logic 51 or a supplemental service library 52. The method 630 commences at operation 632 with the client application program logic 51 communicating a request 561 to the request module 402 in the supplemental service library 52. For example, at startup the client application program 60 may communicate a request for information that may be displayed on a user interface generated by the client application program 60.

At operation 604 the request module 402 in the supplemental service library 52 receives the request 561. At operation 634 the request forwarding module 412 communicates the request 561 to the supplemental service server 24.

At operation 631, at the supplemental service server 24, the receiving module 494 may receive the request 561. At operation 633, the processing module 496 may identify a supplemental service 450 based on the request 561 and communicate the request 561 to the appropriate module that provides the identified supplemental service 450. For example, the processing module 496 may identify that the social networking service 468 is requested and invoke the social networking module 470. At operation 635, the processing module 496 may communicate a response 560 to the mobile device 40. Further, the modules 494, 496, 450 and interfaces 490, 492 at the supplemental service server 24 may use the client application program identifier 69 in the request 561 to identify the client application program 60 or the stand-alone client application program 64 that originated the request 561. Similarly, the modules 494, 496, 450 and interfaces 490, 492 at the supplemental service server 24 may use the mobile device identifier 68 in the request 561 to identify the mobile device 40 that originated the request 561 and automatically identify a user of the mobile device 40.

At operation 636, at the mobile device 40, the response forwarding module 414 receives the response 560 and communicates the response 560 to the client application program logic 51.

At operation 638, the client application program logic 51 receives the response 560 and at operation 640 the client application program logic 51 displays a user interface on the mobile device 40 based on the response 560.

In another embodiment, the above described method 630 may be performed by a stand-alone client application program 64 in conjunction with a supplemental service program 62. In yet another embodiment, the above described method 630 may be performed by a stand-alone client application program 64 in conjunction with a thin client program 66.

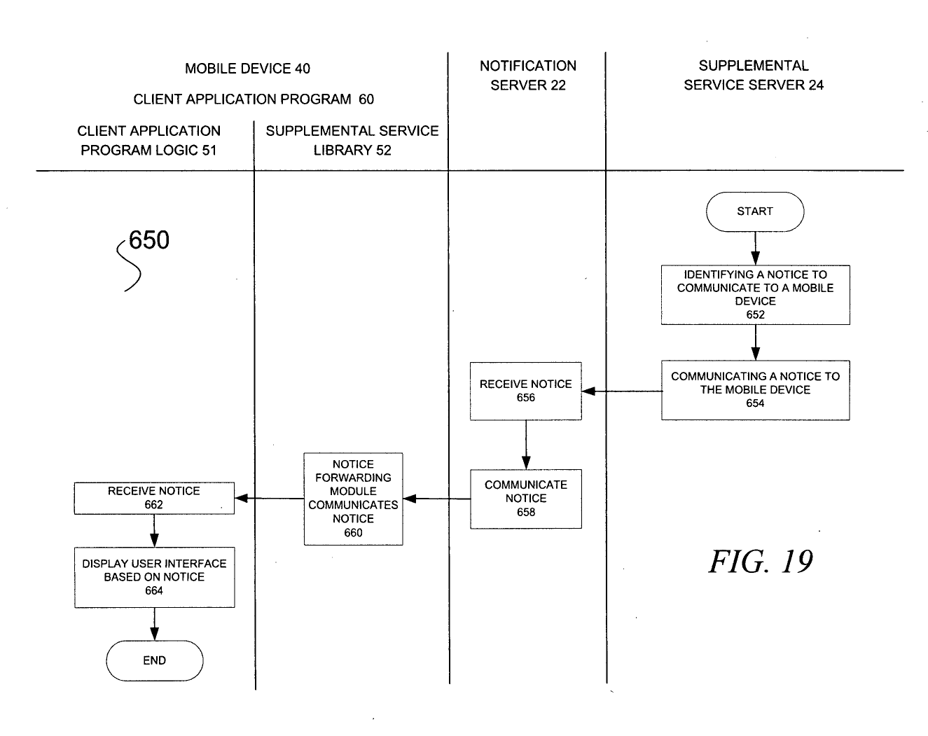

FIG. 19 is a flow chart illustrating a method 650, according to an embodiment, to communicate a notice to a mobile device 40. Illustrated on the left are operations performed on the mobile device 40, illustrated in the middle are operations performed on a notification server 22 and illustrated on the right are operations performed on the supplemental service server 24. With respect to the mobile device 40, the operations are further identified as being performed by client application program logic 51 or a supplemental service library 52. The method 650 commences at operation 652, at the supplemental service server 24 with the processing module 496 identifying a notice to communicate to a mobile device 40. For example, the processing module 496 may identify a notice that is received from an administrative computer system 30 for multicast to mobile devices 40 that use a particular client application program 60 or stand-alone client application program 64. At operation 654, the processing module 496 communicates the notice to the mobile device 40 via the notification server 22.

At operation 656, the notification server 22 receives the notice and at operation 658 the notification server 22 communicates the notice to the appropriate mobile device(s) 40.

At operation 660, at the mobile device 40, the notice forwarding module 410 receives the notice and forwards the notice to the client application program logic 51. At operation 662, the client application program logic 51 receives the notice and at operation 664 the client application program logic 51 displays a user interface based on the notice. In another embodiment, operation 660 may be omitted and the notice may be received from the notification server 22 by the client application program logic 51. In yet another embodiment, operations 660, 662, and 664 may be omitted and the notice may be received from the notification server 22 by the mobile device 40.

In another embodiment, the above described method 650 may be performed by a stand-alone client application program 64 in conjunction with a supplemental service program 62. In yet another embodiment, the above described method 650 may be performed by a stand-alone client application program 64 in conjunction with a thin client program 66.

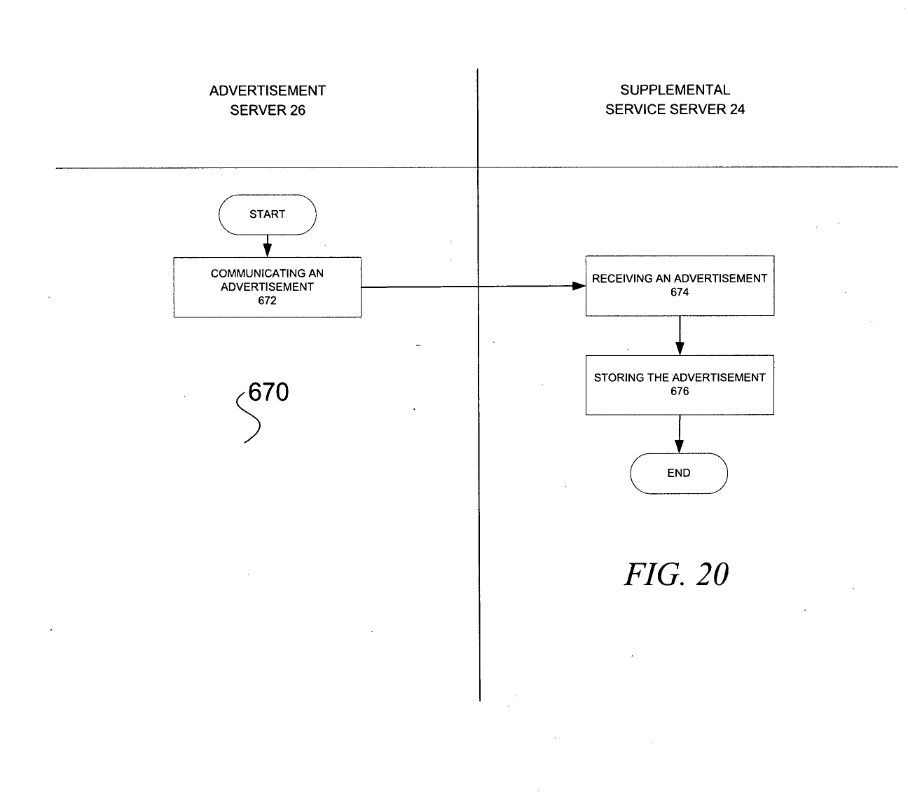

FIG. 20 is a flow chart illustrating a method 670, according to an embodiment, to receive and store an advertisement 566. Illustrated on the left are operations performed on the advertisement server 26 and illustrated on the right are operations performed on the supplemental service server 24. The method 670 commences at operation 672 with the advertisement server 26 communicating an advertisement 566 to the supplemental service server 24.

At operation 674, at the supplemental service server 24, the receiving module 494 receives the advertisement 566 and at operation 676 the processing module 496 stores the advertisement 566 on the data storage device 25.

In another embodiment, the advertisements 566 may be directly loaded onto the data storage device 25. In another embodiment, the advertisements 566 may be created at the supplemental service server 24 and stored on the data storage device 25.

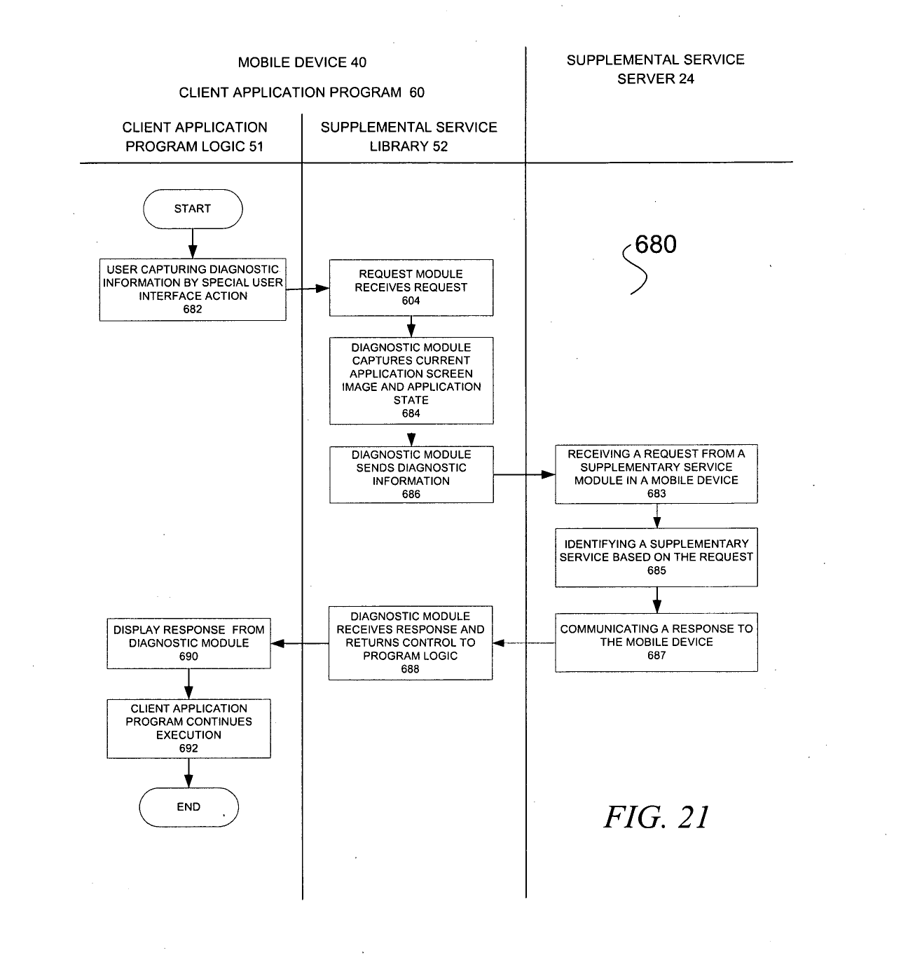

FIG. 21 is a flow chart illustrating a method 680, according to an embodiment, to capture diagnostic information. Illustrated on the left are operations performed on the mobile device 40 and illustrated on the right are operations performed on the supplemental service server 24. With respect to the mobile device 40, the operations are further identified as being performed by client application program logic 51 or a supplemental service library 52. The method 680 commences at operation 682 at the mobile device 40 with a user performing a special user interface action to capture diagnostic information. For example, the user may apply multiple touches to the display of the mobile device 40 to cause the client application program logic 51 to communicate a request 561 to capture diagnostic information. The user may desire to capture the diagnostic information responsive to a failure of the client application program logic 51. At operation 604, the request module 402 in the supplemental service library 52 receives the request 561. At operation 684, the diagnostic module 408 in the supplemental service library 52 captures the diagnostic information and at operation 686 the diagnostic module 408 communicates the diagnostic information to the supplemental service server 24.

At operation 683, at the supplemental service server 24 the receiving module 494 receives the request 561. At operation 685, the processing module 496 identifies a supplemental service 450 based on the request 561 and communicates the request 561 to the appropriate module that provides the identified supplemental service 450. For example, the processing module 496 may identify that the diagnostic service 480 is requested and invoke the diagnostic analysis module 482. The diagnostic analysis module 482 may, in turn, store the diagnostic information as supplemental service information 530 on the data storage device 25. At operation 687, the processing module 496 communicates a response 560 to the mobile device 40. The mobile device 40 and the client application program 60 or stand-alone client application program 64 that originated the request may be identified as previously described.

At operation 688, at the mobile device 40, the diagnostic module 408 receives the response 560 and returns control to the client application program logic 51.

At operation 690, the client application program logic 51 receives the response 560 and at operation 692 the client application program 60 continues execution.

In another embodiment, the above described method 630 may be performed by a stand-alone client application program 64 in conjunction with a supplemental service program 62.

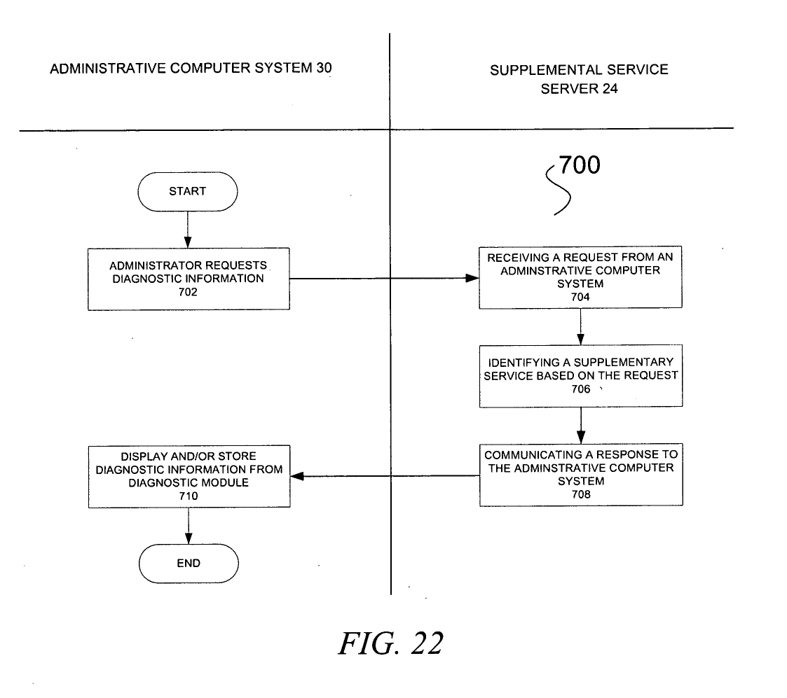

FIG. 22 is a flow chart illustrating a method 700, according to an embodiment, to report diagnostic information. Illustrated on the left are operations performed on the administrative computer system 30 and illustrated on the right are operations performed on the supplemental service server 24. The method 700 commences at operation 702 with the administrative computer system 30 communicating a request for diagnostic information. For example, an administrator at the administrative computer system 30 may request the diagnostic information.

At operation 704, at the supplemental service server 24, the receiving module 494 receives the request 561. At operation 706, the processing module 496 identifies a supplemental service 450 based on the request 561 and communicates the request 561 to the appropriate module that provides the identified supplemental service 450. For example, the processing module 496 may identify that the diagnostic service 480 is requested and invoke the diagnostic analysis module 482 to retrieve the diagnostic information from the supplemental service information 530 on the data storage device 25. At operation 708, the processing module 496 communicates a response to the administrative computer system 30.

At operation 710, the administrative computer system 30 displays the diagnostic information. In addition, the administrative computer system 30 may store the diagnostic information on the data storage device 31.

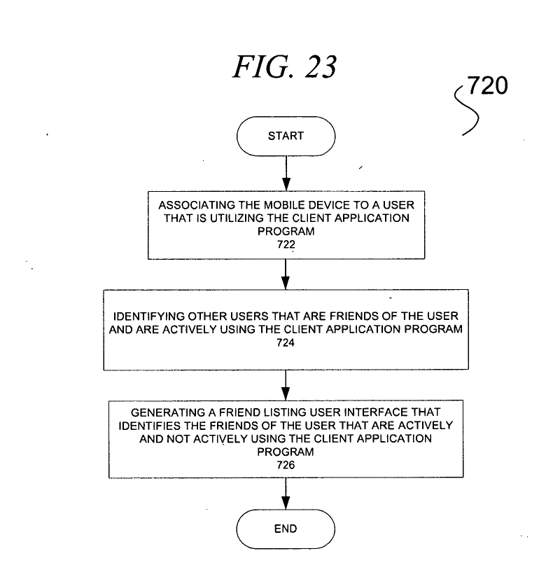

FIG. 23 is a flow chart illustrating a method 720, according to an embodiment, to generate a user interface that identifies active and inactive users of a client application program 60. At operation 722 the social networking module 470 associates a mobile device 40 to a user that is utilizing the client application program 60. For example, the social networking module 470 may utilize the mobile device identifier 68 and the client application program identifier 69 in a request 561 to access supplemental service information 530 for the user profile service 464 that identifies the user. At operation 724 the social networking module 470 may identify other users that are friends of the user and are actively using the client application program 60. For example, the social networking module 470 may utilize the supplemental service information 530 for the social networking service 468 that identifies the friends of the user and whether any of the friends are actively using the client application program 60. For example, the supplemental service information 530 may include a status for each friend that indicates whether the friend is actively or not actively using the client application program 60. At operation 726 the social networking module 470 generates the information to display a user interface in the form of a friend listing user interface that identifies the friends of the user that are actively and not actively using the client application program 60. In one embodiment the user interface information may be communicated to the mobile device 40 as interface response information 562 in a response 560.

In another embodiment, the above described method 720 may be performed to generate a user interface that identifies active and inactive users of a stand-alone client application program 64.

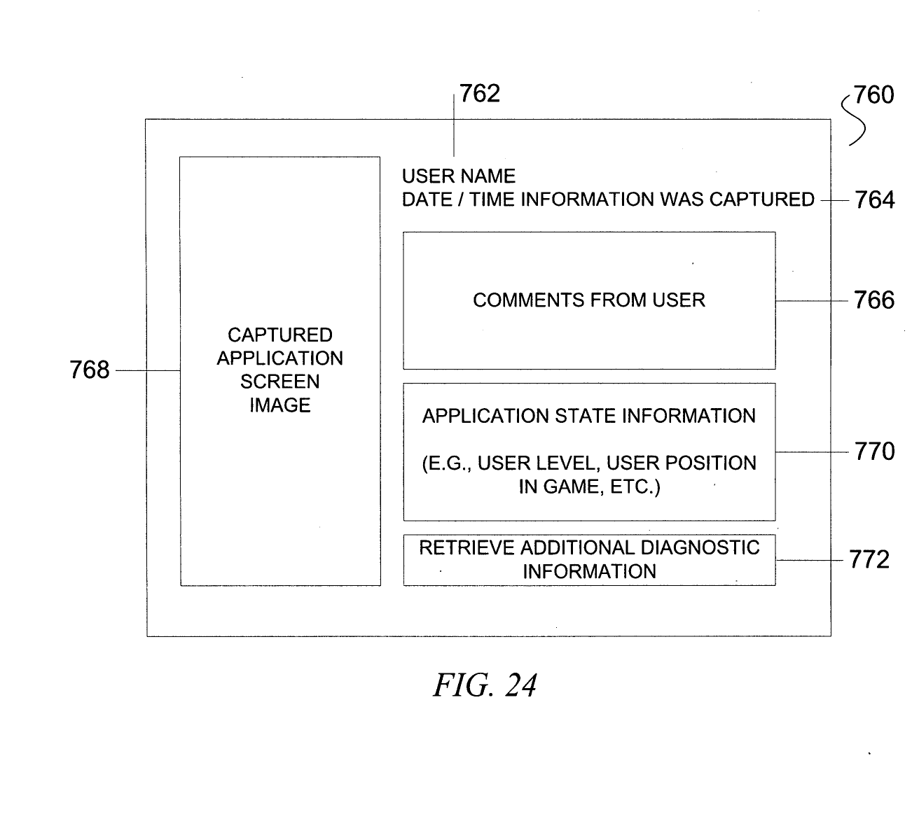

FIG. 24 is a diagram illustrating a user interface 760, according to an embodiment, to present diagnostic information. The user interface 760 may be communicated by the supplemental service server 24 for presentation on a video display that is coupled to an administrative computer system 30. The user interface 760 may be communicated in a response to a request from the administrative computer system 30. In one embodiment the request may be communicated by an administrator that operates the administrative computer system 30. For example, the administrator may request the diagnostic information to identify a reason for a failure of a client application program 60, a stand-alone client application program 64, a supplemental service program 62 or a thin client program 66 at a mobile device 40. The diagnostic information may include user name information 762, date and time information 764, comments information 766, an image 768 of a captured application screen, and application state information 770. The user name information 762 may include the name of the user that is associated with the mobile device 40. The date and time information 764 may include the date and time that the diagnostic information was captured at the mobile device 40 before being communicated to the supplemental service server 24. The comments information 766 may include comments that are received by the mobile device 40, as entered by the user. For example, the user may enter text that reports activity that was observed at failure. The image 768 may include the screen or user interface that was presented on the video display of the mobile device 40 at the time the diagnostic information was captured at the mobile device 40. The application state information 770 may include a program counter, the contents of registers, a specified block of memory or some other information that was recorded at the time the diagnostic information was captured at the mobile device 40. The user interface 760 may include a user interface element 772 that may be selectable to cause the administrative computer system 30 to retrieve additional diagnostic information from the supplemental service server 24. For example, the additional diagnostic information may enable recreation of a captured application state in a client application program development environment.

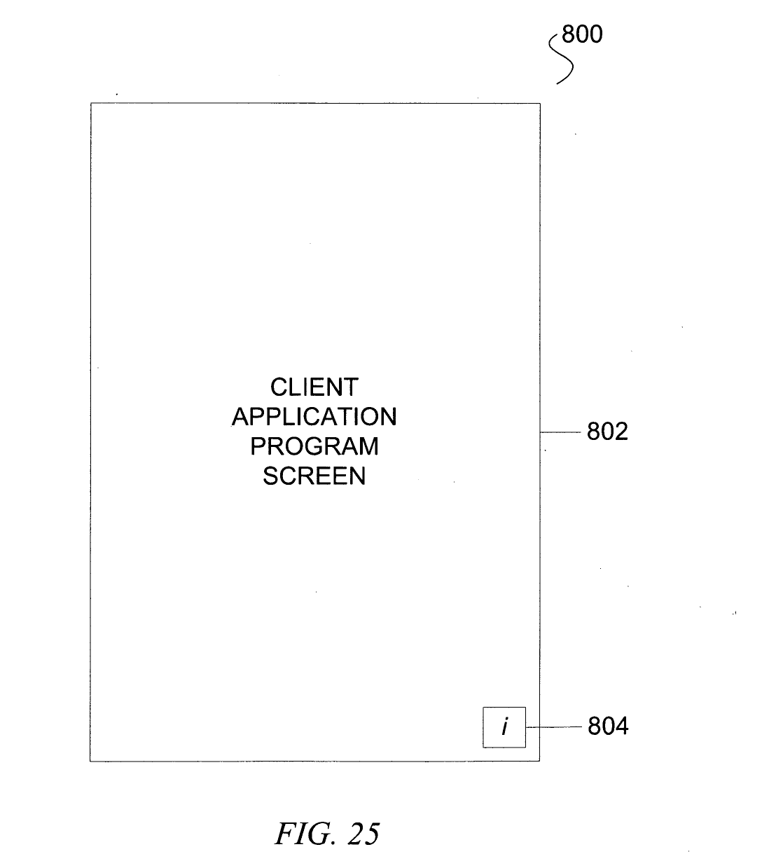

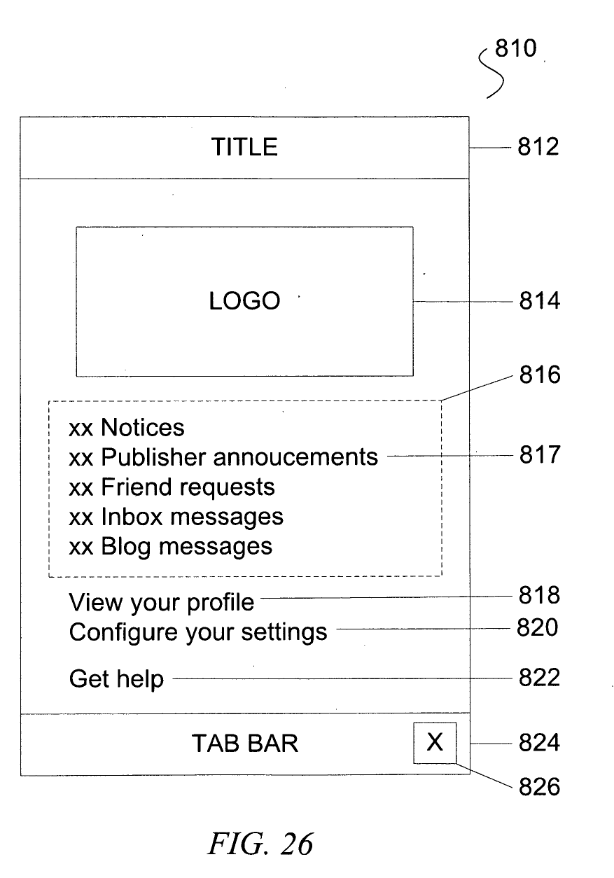

FIG. 25 is a diagram illustrating a user interface 800, according to an embodiment, to present a client application program user interface. The user interface 800 may be presented on a video display that is coupled to a mobile device 40. The user interface 800 may be generated by a client application program 60 or a stand-alone client application program 64 on a mobile device 40. The user interface 800 may be in the form of a client application program screen 802 that includes a home user interface element 804. The client application program screen 802 may include user interface elements generated by a client application program 60 or a stand-alone client application program 64. In one embodiment the home user interface element 804 may be selectable to cause the client application program 60 or the stand-alone client application program 64 to retrieve information from a supplemental service library 52. For example, the information may include a count of new notices, a count of new publisher announcements, a count of new friend requests, a count of new inbox messages, a count of new blog messages, and other information. In another embodiment, the home user interface element 804 may be selectable to communicate a request to supplemental service library 52 to display a home user interface 810 as illustrated in FIG. 26.

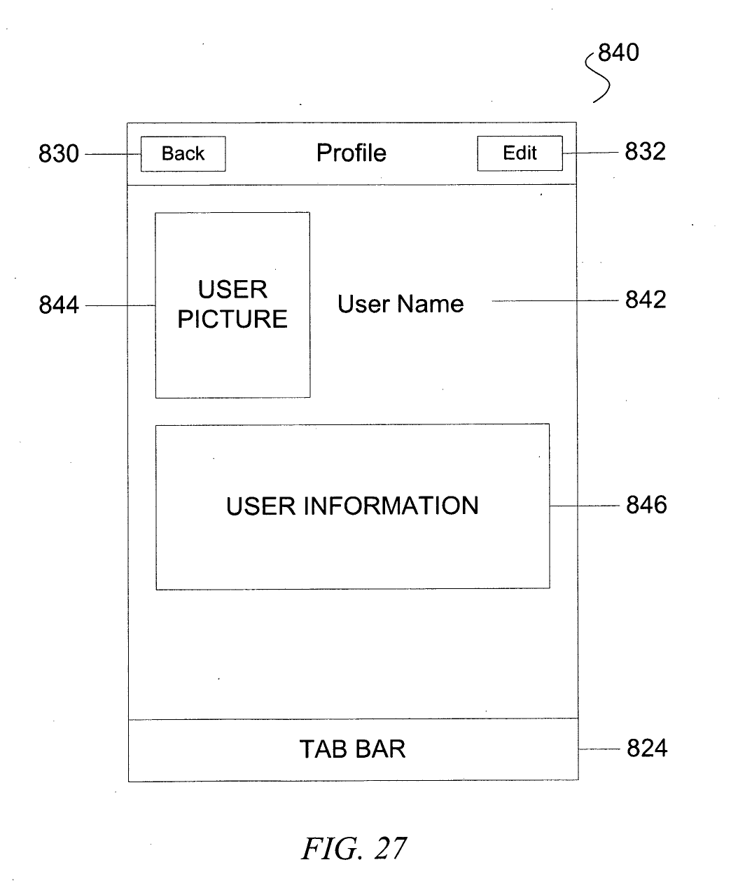

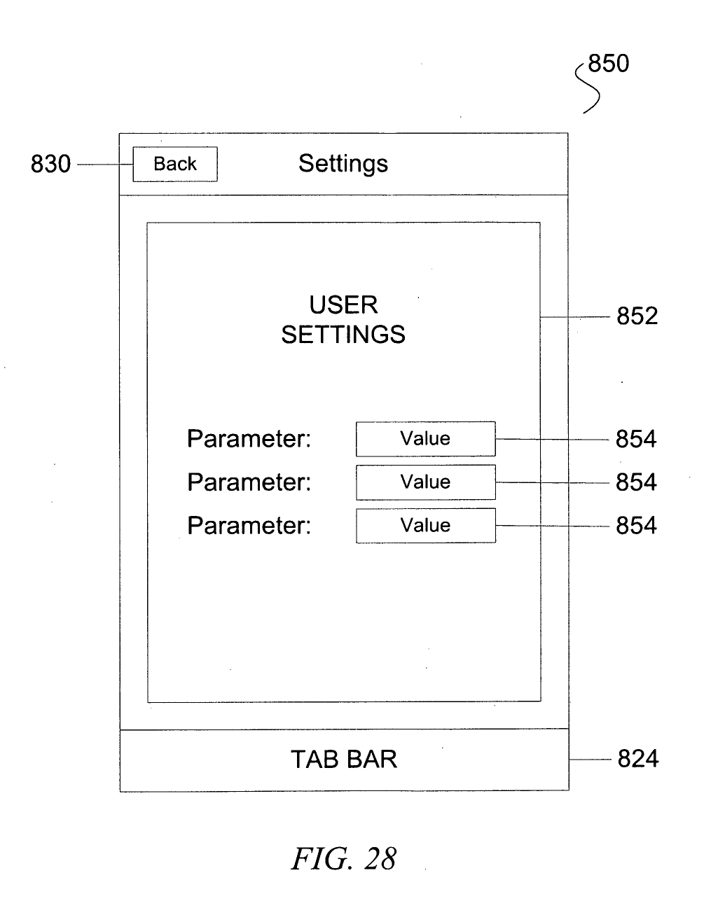

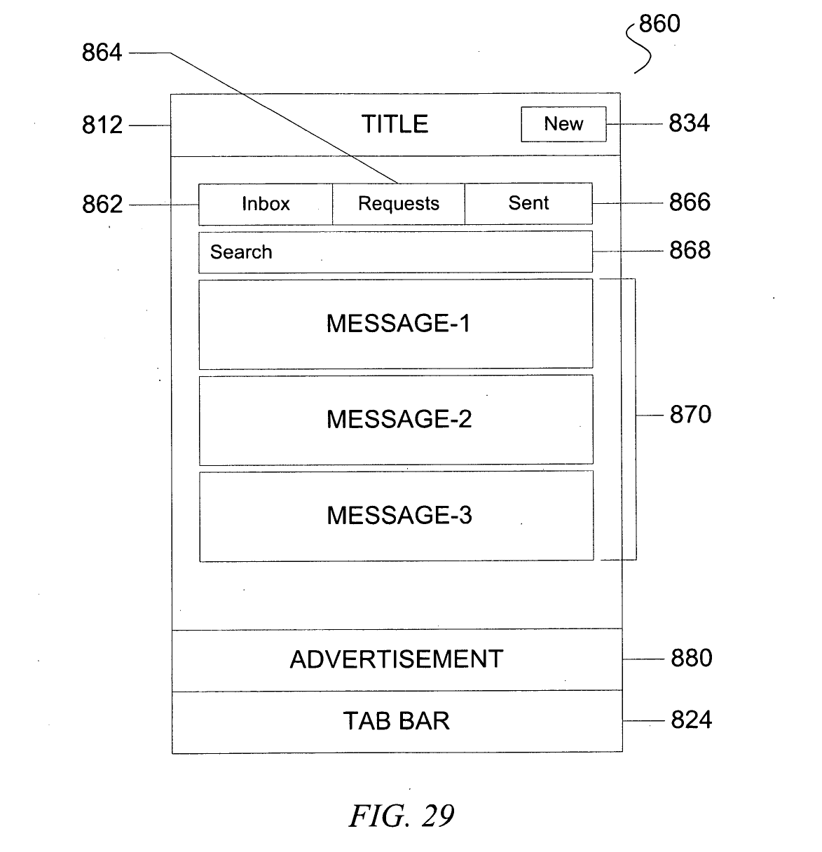

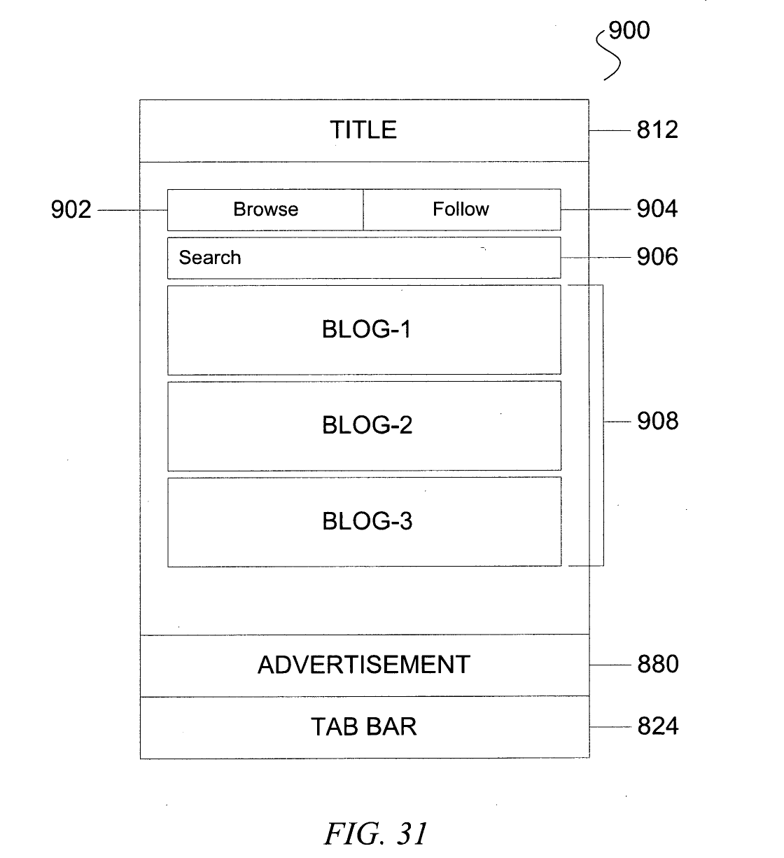

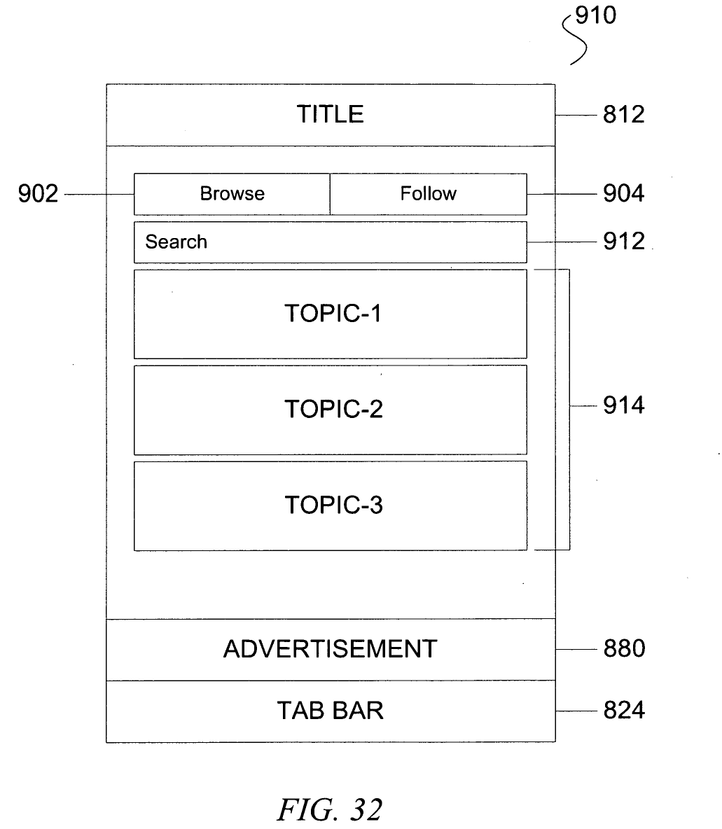

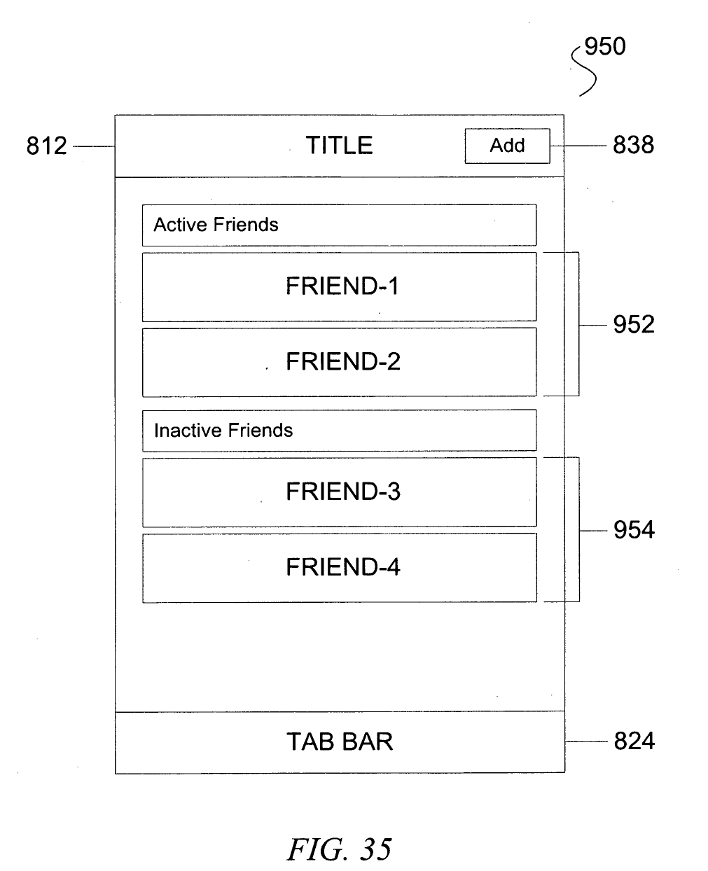

FIG. 26 is a diagram illustrating a user interface 810, according to an embodiment, to present a home user interface. The user interface 810 may be presented on a video display that is coupled to a mobile device 40. The user interface 810 may be generated and presented by a supplemental service library 52 on the mobile device 40. The user interface 810 may include a title bar 812, a logo image 814, status information 816, a publisher announcement user interface element 817, a user profile user interface element 818, a user settings user interface element 820, a help user interface element 822, a tab bar user interface element 824, and an exit user interface element 826. The title bar 812 may include the text of a title. For example, the title bar 812 may include a title (e.g., trade name) of the client application program 60 or stand-alone client application program 64. The logo image 814 may include an image of a logo. For example, the image (e.g., trademark) may be associated by the public with the client application program 60 or stand-alone client application program 64. The status information 816 may include status information for the mobile device 40. For example, the status information 816 may include a count of new notices, a count of new publisher announcements, a count of new friend requests, a count of new inbox messages, a count of new blog messages, and other information that may have been communicated to the mobile device 40. The publisher announcement user interface element 817 may be selectable to display the announcements that have been communicated to the mobile device 40 from a publisher of a client application program 60 or a stand-alone client application program 64. The user profile user interface element 818 may be selectable to display a user profile user interface 840 as illustrated in FIG. 27. The user settings user interface element 820 may be selectable to display a user settings user interface 850 as illustrated in FIG. 28. The help user interface element 822 may be selectable to display help information. For example, the help user interface element 822 may display help information explaining the use of the search function to find information in blogs. The tab bar user interface element 824 may include user interface elements that are respectively selectable to present the home user interface 810, a message listing user interface 860 as illustrated in FIG. 29, a blog listing user interface as illustrated in FIG. 31 and FIG. 32, and a friend listing user interface as illustrated in FIG. 35. The exit user interface element 826 may be selectable to exit user interface 810. In one embodiment exiting user interface 810 may return control to a client application program 60 or a stand-alone client application program 64.

FIG. 27 is a diagram illustrating a user interface 840, according to an embodiment, to present a user profile. The user interface 840 may be presented on a video display that is coupled to a mobile device 40. The user interface 840 may be generated and presented by a supplemental service library 52 on the mobile device 40. The user interface 840 may include a back user interface element 830, an edit user interface element 832, user name information 842, a user picture 844, user information 846, and a tab bar user interface element 824. The back user interface element 830 may be selectable to display the previously displayed user interface. The edit user interface element 832 may be selectable to edit and/or update the currently displayed information. The user name information 842 may include the name of the user that is associated with the mobile device 40. The user picture 844 may include a picture that is associated with the user that is associated with the mobile device 40. The picture may be associated with the user that is associated with the mobile device 40 and a client application program 60 or a stand-alone client application program 64. The user information 846 may include information about the user that is associated with the mobile device 40. For example, the user information 846 may include the real name of the user, the email address of the user, the website of the user, the geographic location of the user, the hobbies and interests of the user, and other information about the user.

FIG. 28 is a diagram illustrating a user interface 850, according to an embodiment, to present user settings. The user interface 850 may be presented on a video display that is coupled to a mobile device 40. The user interface 850 may be generated and presented by a supplemental service library 52 on the mobile device 40. The user interface 850 may include a back user interface element 830, user settings 852, parameter user interface elements 854, and a tab bar user interface element 824. The user settings 852 may include user configurable settings to configure a client application program 60 or a stand-alone client application program 64. For example, the user settings 852 may include the difficulty level for an arcade game application program, the default geographic location for a movie listings application program, or the default expense account for an expense tracker application program. The parameter user interface elements 854 may receive parameter information that is utilized to configure a client application program 60 or a stand-alone client application program 64.

FIG. 29 is a diagram illustrating a user interface 860, according to an embodiment, to present a message listing. The user interface 860 may be presented on a video display that is coupled to a mobile device 40. The user interface 860 may be generated and presented by a supplemental service library 52 on the mobile device 40. The user interface 860 may include a title bar 812, a new user interface element 834, an inbox user interface element 862, a requests user interface element 864, a sent user interface element 866, search input box user interface element 868, a message frame 870, an advertisement frame 880, and a tab bar user interface element 824. The new user interface element 834 may be selectable to display a user interface that receives a new message. The inbox user interface element 862 may be selectable to cause the message frame 870 to display messages. For example, selection of the inbox user interface element 862 may cause the message frame 870 to display messages that have been communicated to the mobile device 40 from other mobile devices 40. In one embodiment the other mobile devices 40 may be limited to mobile devices 40 that utilize client application programs 60 or stand-alone client application programs 64 in common with the mobile device 40. The requests user interface element 864 may be selectable to cause the message frame 870 to display messages that are friend requests that have been communicated to the mobile device 40. The sent user interface element 866 may be selectable to cause message frame 870 to display messages that have been communicated from the mobile device 40. The search input box user interface element 868 may include an input box that receives at least one keyword that is used to search the messages that have been communicated to or from the mobile device 40. Accordingly, the message frame 870 may be utilized to display the messages and other information in response to the request to search. The information associated with the messages may include the user name of a user that communicated a message, the date and time a message was communicated, the subject of a message, a summary of a message, and other information about a message. The advertisement frame 880 may include an advertisement 566. In one embodiment the advertisement 566 may be communicated from the supplemental service server 24 to the mobile device 40. In another embodiment the advertisement 566 may be retrieved by the supplemental service library 52 from an advertisement server 26. In one embodiment the retrieving may be based on advertisement retrieval information 568 that is received in a response 560.

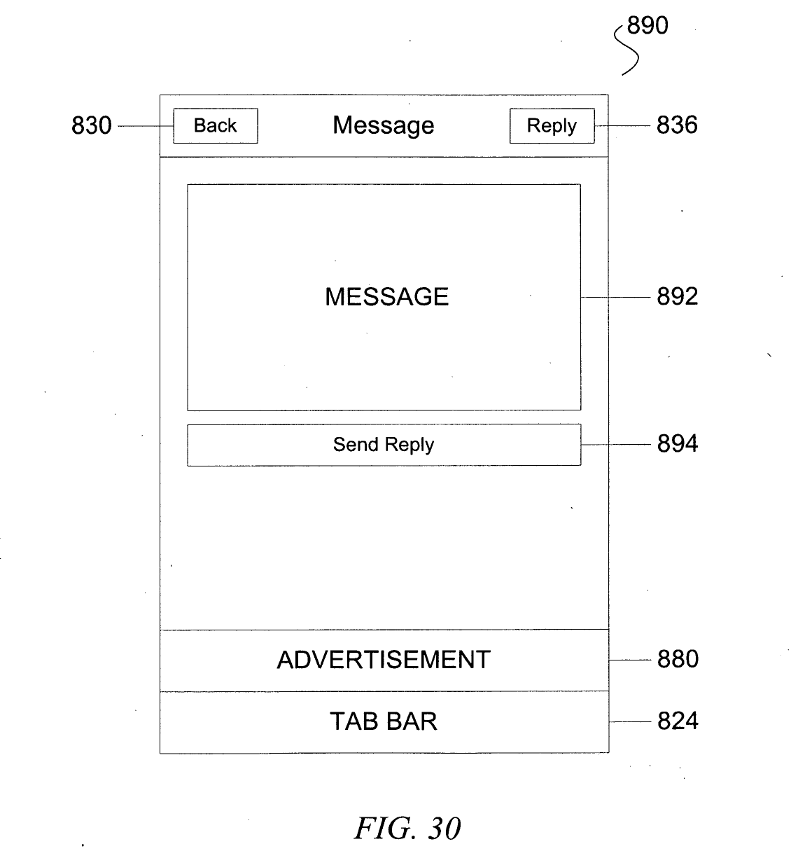

FIG. 30 is a diagram illustrating a user interface 890, according to an embodiment, to present a message display. The user interface 890 may be presented on a video display that is coupled to a mobile device 40. The user interface 890 may be generated and presented by a supplemental service library 52 on the mobile device 40. The user interface 890 may include a back user interface element 830, a reply user interface element 836, a message frame 892, a send reply user interface element 894, an advertisement frame 880, and a tab bar user interface element 824. The reply user interface element 836 and the send reply user interface element 894 may be selectable to display a user interface that receives a reply to a message that is currently displayed in the message frame 892. The message frame 892 may further include information associated with the message that was communicated to or from the mobile device 40. For example, the information associated with the message may include a user name of the user from whom the message was received, a date and time the message was received, a subject of the message, the text of the message, and other information associated with the message. In another embodiment the message frame 892 may include messages and associated information that are associated with any client application program 60 or stand-alone client application program 64 on the mobile device 40. For example, the message frame 892 may include messages associated with the client application program 60 that invoked the supplemental service library 52 to request display of the user interface 890 and also messages from other client application programs 60 or stand-alone client application programs 64 on the mobile device 40.

FIG. 31 is a diagram illustrating a user interface 900, according to an embodiment, to present a blog listing in browse mode. The user interface 900 may be presented on a video display that is coupled to a mobile device 40. The user interface 900 may be generated and presented by a supplemental service library 52 on the mobile device 40. The user interface 900 may include a title bar 812, a browse user interface element 902, a follow user interface element 904, a search input box user interface element 906, a blog frame 908, an advertisement frame 880, and a tab bar user interface element 824. The browse user interface element 902 may appear on other user interfaces and is selectable from the other user interfaces to display the presently illustrated blog listing user interface 900. The follow user interface element 904 may be selectable to display a blog listing user interface 910 as illustrated in FIG. 32. The search input box user interface element 906 may include an input box that receives at least one keyword that is used to search one or more blogs that are accessible over the network 12. The blog frame 908 may include information for one or more blogs that are accessible over the network 12. For example, the blog frame 908 may include blog information associated with a blog. The blog information may include a name of the blog, a description of the blog, a total number of messages in the blog, a number of new messages in the blog, a date and time of the most recent message in the blog, and other information associated with the blog.

FIG. 32 is a diagram illustrating a user interface 910, according to an embodiment, to present a blog listing in follow mode. The user interface 910 may be presented on a video display that is coupled to a mobile device 40. The user interface 910 may be generated and presented by a supplemental service library 52 on the mobile device 40. The user interface 910 may include a title bar 812, a browse user interface element 902, a follow user interface element 904, a search input box user interface element 912, a topic frame 914, an advertisement frame 880, and a tab bar user interface element 824. The browse user interface element 902 may be selectable to display a blog listing user interface 900 as illustrated in FIG. 31. The follow user interface element 904 may appear on other user interfaces and is selectable from the other user interfaces to display the presently illustrated blog listing user interface 910. The search input box user interface element 912 may include an input box that receives at least one keyword that is used to search one or more topics that are being followed from the mobile device 40. For example, the one or more topics may be respectively presented on one or more blogs that are accessible over the network 12. The topic frame 914 may include information for one or more topics that are being followed by the mobile device 40. For example, the topic frame 914 may include topic information for topics presented on blogs that are accessible over the network 12. The topic information for a particular topic may include a subject of the topic, a user name of the user that created the topic, a date and time the topic was created, a number of mobile devices 40 that are following the topic, a total number of replies associated with the topic, a number of new replies associated with the topic, a date and time of the most recent reply associated with the topic, and other information associated with the topic.

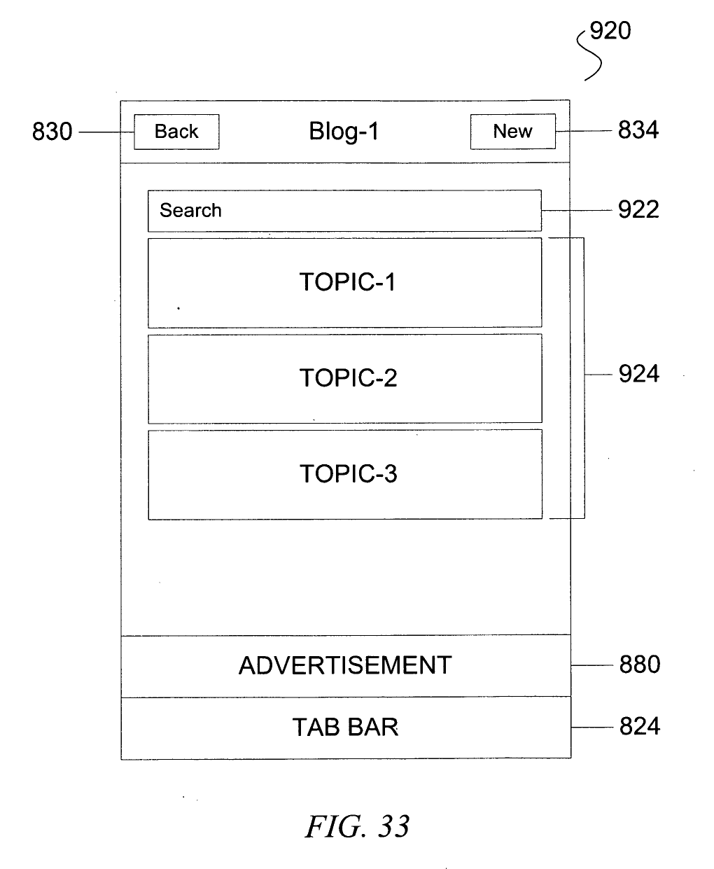

FIG. 33 is a diagram illustrating a user interface 920, according to an embodiment, to present a topic listing. The user interface 920 may be presented on a video display that is coupled to a mobile device 40. The user interface 920 may be generated and presented by a supplemental service library 52 on the mobile device 40. The user interface 920 may include a back user interface element 830, a new user interface element 834, a search input box user interface element 922, a topic frame 924, an advertisement frame 880, and a tab bar user interface element 824. The new user interface element 834 may be selectable to display a user interface that receives a new topic. The search input box user interface element 922 may include an input box that receives at least one keyword that is used to search one or more topics that are respectively presented on one or more blogs that are accessible over the network 12. The topic frame 924 may include information for one or more topics. For example, the topic frame 924 may include topic information for multiple topics presented on blogs that are accessible over the network 12. The topic information for a particular topic may include a subject of the topic, a user name of the user that created the topic, a date and time the topic was created, a number of mobile devices 40 that are following the topic, a total number of replies associated with the topic, a number of new replies associated with the topic, a date and time of the most recent reply associated with the topic, and other information associated with the topic.

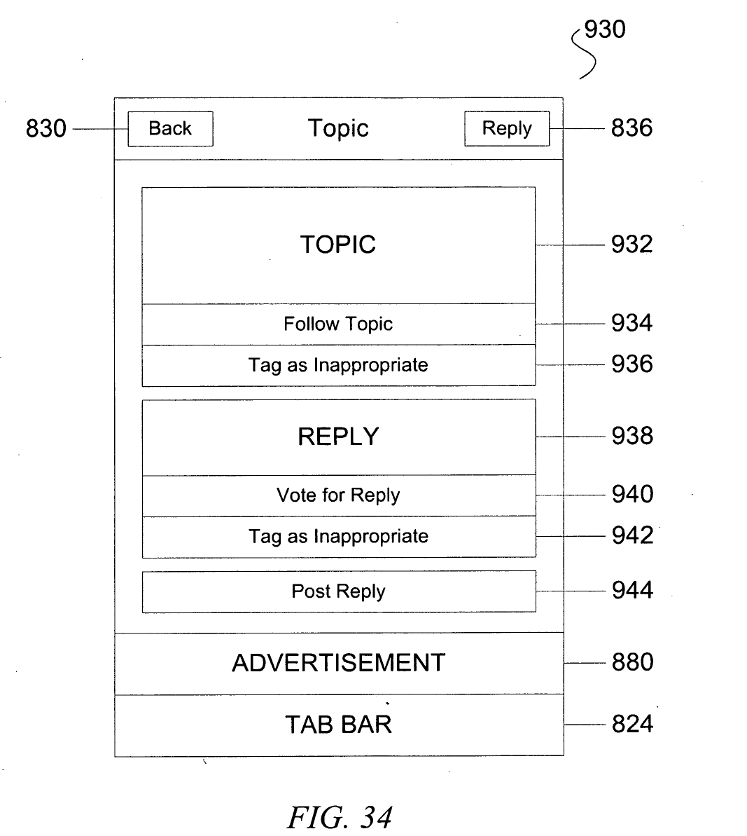

FIG. 34 is a diagram illustrating a user interface 930, according to an embodiment, to present a topic display. The user interface 930 may be presented on a video display that is coupled to a mobile device 40. The user interface 930 may be generated and presented by a supplemental service library 52 on the mobile device 40. The user interface 930 may include a back user interface element 830, a reply user interface element 836, a topic 932, a follow topic user interface element 934, a tag as inappropriate user interface element 936, a reply frame 938, vote for reply frame 940, a tag as inappropriate frame 942, a post reply user interface element 944, an advertisement frame 880, and a tab bar user interface element 824. The reply user interface element 836 and the post reply user interface element 944 may be selectable to display a user interface that receives a new reply to the currently displayed topic. The topic 932 may include information for a topic that is presented on a blog that is accessible over the network 12. For example, the topic 932 may include a subject of the topic, a user name of the user that created the topic, a date and time the topic was created, a number of mobile devices 40 that are following the topic, a total number of replies associated with the topic, a number of new replies associated with the topic, a date and time of the most recent reply associated with the topic, and other information associated with the topic. The follow topic user interface element 934 may be selectable to communicate information to the supplemental service server 24 that the mobile device 40 is following a topic. In one embodiment the supplemental service server 24 may use this information to communicate to the mobile device 40 the receipt of replies that are associated with the topic being followed by the mobile device 40. The tag as inappropriate user interface element 936 may be selectable to communicate information to a supplemental service server 24 that a topic is inappropriate. In one embodiment the supplemental service server 24 may use this information to disassociate the topic from its associated blog. The reply frame 938 may include information for one or more replies that are associated with a topic. For example, the information for a particular reply may include a user name of the user that created the reply, a date and time the reply was created, a number of votes for the reply, the text of the reply, or other information associated with the reply. The vote for reply frame 940 may include multiple user interface elements that are respectively selectable to communicate information to a supplemental service server 24 that the corresponding reply should receive a vote. In one embodiment the supplemental service server 24 may use this information to determine a level of relevance between the reply and the associated topic. The tag as inappropriate frame 942 may include multiple user interface elements that are respectively selectable to communicate information to a supplemental service server 24 that a corresponding reply is inappropriate. In one embodiment the supplemental service server 24 may use this information to disassociate the reply from the associated topic.

FIG. 35 is a diagram illustrating a user interface 950, according to an embodiment, to present a friend listing. The user interface 950 may be presented on a video display that is coupled to a mobile device 40. The user interface 950 may be generated and presented by a supplemental service library 52 on a mobile device 40. The user interface 950 may include a title bar 812, an add user interface element 838, an active friends frame 952, an inactive friends frame 954, and a tab bar user interface element 824. The add user interface element 838 may be selectable to display a user interface that receives a friend request message. The active friends frame 952 may include information for one or more users that have a friend relationship with the user of the mobile device 40 and that have been identified as actively utilizing a client application program 60 or stand-alone client application program 64 in common with the user of the mobile device 40. The inactive friends frame 954 may include information for one or more users that have a friend relationship with the user of the mobile device 40 and that have been identified as not actively utilizing a client application program 60 or stand-alone client application program 64 in common with the user of the mobile device 40. The information for an active or inactive friend may include a user name of the user, a user picture associated with the user, and other information associated with the user.

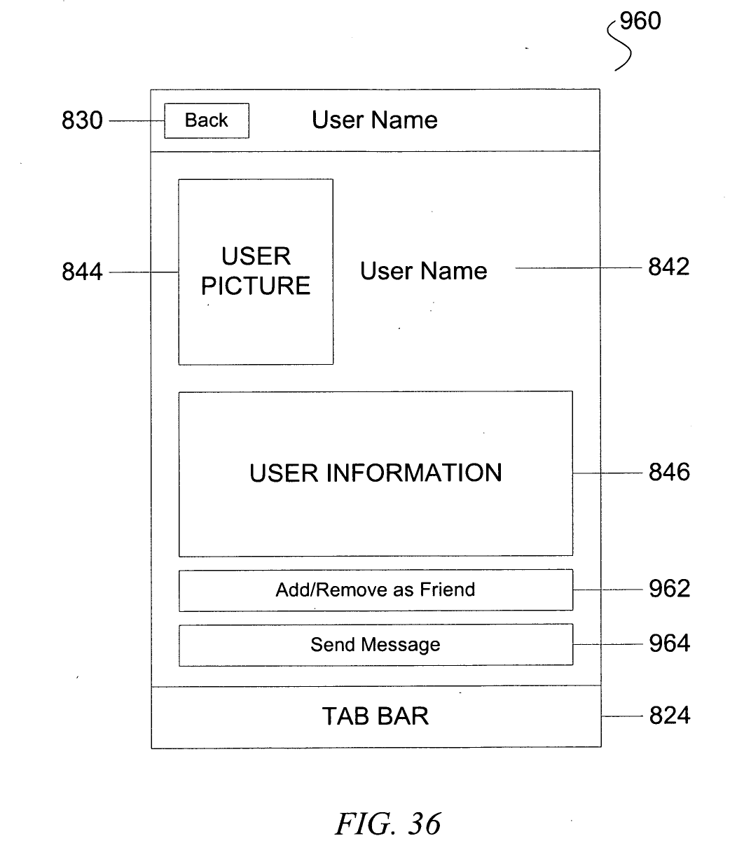

FIG. 36 is a diagram illustrating a user interface 960, according to an embodiment, to present a friend display. The user interface 960 may be presented on a video display that is coupled to a mobile device 40. The user interface 960 may be generated and presented by a supplemental service library 52 on the mobile device 40. The user interface 960 may include a back user interface element 830, user name information 842 for the friend, a user picture 844 of the fried, user information 846 for the friend, an add/remove as friend user interface element 962, a send message user interface element 964 to send a message to the friend, and a tab bar user interface element 824. The user name information 842 may include the name of a user that has a friend relationship with the user of the mobile device 40. The user picture 844 may include a picture that is associated with a user that has a friend relationship with the user of the mobile device 40. The user information 846 may describe the user. For example, the user information 846 may include a name of the user, an email address of the user, a website associated with the user, a geographic location associated with the user, one or more hobbies and interests of the user, and other information that characterizes the user. The add/remove as friend user interface element 962 may be selectable to communicate information to a supplemental service server 24 to add or remove the friend relationship between the friend depicted on the user interface 960 and the user of the mobile device 40. The send message user interface element 964 may be selectable to display a user interface that receives a message for communication to the friend.

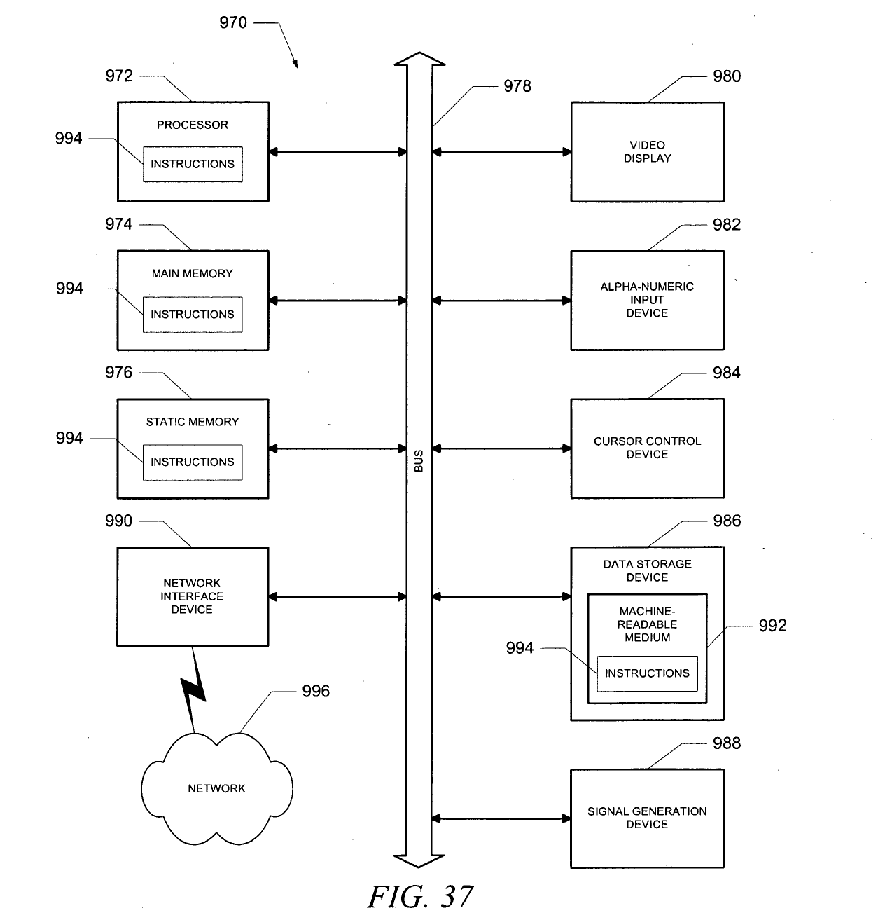

FIG. 37 shows a diagrammatic representation of a machine in the form of a computer system 970 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in client-server network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, an administrative computer system 30, a mobile device 40, an application store server 20, a notification server 22, a supplemental service server 24, an advertisement server 26 or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The computer system 970 may include a processor 972 (e.g., a central processing unit (CPU) a graphics processing unit (GPU) or both), a main memory 974 and a static memory 976, which communicate with each other via a bus 978. The computer system 970 may further include a video display unit 980 (e.g., a liquid crystal display (LCD) or a cathode ray tube (CRT)). The computer system 970 may also include an alphanumeric input device 982 (e.g., a keyboard), a cursor control device 984 (e.g., a mouse), a data storage device 986, a signal generation device 988 (e.g., a speaker) and a network interface device 990.

The data storage device 986 includes a machine-readable medium 922 on which is stored one or more sets of instructions (e.g., software 994) embodying any one or more of the methodologies or functions described herein. The software 994 may also reside, completely or at least partially, within the main memory 974 and/or within the processor 972 during execution thereof by the computer system 970, the main memory 974 and the processor 972 also constituting machine-readable media.

The software 994 may further be transmitted or received over a network 996 via the network interface device 990.

While the machine-readable medium 992 is shown in an embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present application. The term “machine-readable medium” shall accordingly be taken to include, but not be limited to, solid-state memories, optical media and magnetic media.

### Technology

The methods and systems described herein may be embodied in any one or more of the following technologies.

### C

C is an imperative (procedural) systems implementation language that was designed to be compiled using a relatively straightforward compiler, to provide low-level access to memory, to provide language constructs that map efficiently to machine instructions, and to require minimal run-time support. Despite its low-level capabilities, the language was designed to encourage machine-independent programming. A standards-compliant and portably written C program can be compiled for a very wide variety of computer platforms and operating systems with little or no change to its source code, while approaching highest performance. The language has become available on a very wide range of platforms, from embedded microcontrollers to supercomputers.

### Objective-C

Objective-C is a reflective, object-oriented programming language which adds Smalltalk-style messaging to C. Objective-C is a very thin layer on top of C that implements a strict superset of C. That is, it is possible to compile any C program with an Objective-C compiler. Objective-C derives its syntax from both C and Smalltalk. Most of the syntax (including preprocessing, expressions, function declarations, and function calls) is inherited from C, while the syntax for object-oriented features was created to enable Smalltalk-style messaging.

### Java

Java is a portable, object-oriented programming language that allows computer programs written in the Java language to run similarly on any supported hardware/operating-system platform. One should be able to write a program once, compile it once, and run it anywhere. This is achieved by compiling the Java language code, not to machine code but to Java bytecode—instructions analogous to machine code but intended to be interpreted by a virtual machine (VM) written specifically for the host hardware. End-users commonly use a Java Runtime Environment (JRE) installed on their own machine for standalone Java applications, or in a Web browser for Java applets. Standardized libraries provide a generic way to access host specific features such as graphics, threading and networking. In some JVM versions, bytecode can be compiled to native code, either before or during program execution, resulting in faster execution.

### JavaScript

JavaScript is a client-side object scripting language used by millions of Web pages and server applications. With syntax similar to Java and C++, JavaScript may behave as both a procedural and object oriented language. JavaScript is interpreted at run time on the client computer and provides various features to a programmer. Such features include dynamic object construction, function variables, dynamic script creation, and object introspection. JavaScript is commonly used to provide dynamic interactivity to Web pages and interact with a page DOM hierarchy.

### Ruby

Ruby is a dynamic, reflective, general-purpose object-oriented programming language that combines syntax inspired by Perl with Smalltalk-like features. Ruby supports multiple programming paradigms, including functional, object-oriented, imperative and reflective. It also has a dynamic type system and automatic memory management; it is therefore similar in varying respects to Python, Perl, Lisp, Dylan, and CLU.

### Web Services

A Web service (also Web Service) is defined by the W3C as “a software system designed to support interoperable machine-to-machine interaction over a network”. Web services are frequently just Web APIs that can be accessed over a network, such as the Internet, and executed on a remote system hosting the requested services. The W3C Web service definition encompasses many different systems, but in common usage the term refers to clients and servers that communicate over the HTTP protocol used on the Web. RESTful Web services are Web services that are based on the concept of representational state transfer (REST).

### Representational State Transfer (REST)

Representational state transfer (REST) is a style of software architecture for distributed hypermedia systems such as the World Wide Web. An important concept in REST is the existence of resources (sources of specific information), each of which is referenced with a global identifier (e.g., a URI in HTTP). In order to manipulate these resources, components of the network (user agents and origin servers) communicate via a standardized interface (e.g., HTTP) and exchange representations of these resources (the actual documents conveying the information). For example, a resource that is a circle may accept and return a representation that specifies a center point and radius, formatted in SVG, but may also accept and return a representation that specifies any three distinct points along the curve as a comma-separated list.

### XML

The Extensible Markup Language (XML) is a general-purpose specification for creating custom markup languages. It is classified as an extensible language, because it allows the user to define the mark-up elements. XML's purpose is to aid information systems in sharing structured data, especially via the Internet, to encode documents, and to serialize data; in the last context, it compares with text-based serialization languages such as JSON, YAML and S-Expression.

### JSON

JSON is an acronym for JavaScript Object Notation, and is a lightweight data exchange format. Commonly used in AJAX applications as an alternative to XML, JSON is human readable and easy to handle in client-side JavaScript. A single function call to eval( ) turns a JSON text string into a JavaScript object. Such objects may easily be used in JavaScript programming, and this ease of use is what makes JSON a good choice for AJAX implementations.

### AJAX

AJAX is an acronym for Asynchronous JavaScript and XML but has become synonymous for JavaScript applications that use the HTTP Request object. AJAX allows websites to asynchronously load data and inject it into the website without doing a full page reload. Additionally AJAX enables multiple asynchronous requests before receiving results. Overall the capability to retrieve data from the server without refreshing the browser page allows separation of data and format and enables greater creativity in designing interactive Web applications.

### HTML Push/Comet

Comet is similar to AJAX inasmuch as it involves asynchronous communication between client and server. However, Comet applications take this model a step further because a client request is no longer required for a server response.

### Other Technologies

An example embodiment may be implemented as a dynamic interface and use a set of tools consistent with this platform. In one embodiment, the server technology may include Tomcat and utilize a custom Ruby on Rails application that interfaces with a MySQL database. In one embodiment, the communication protocol used for client-server communication may be RESTful Web services with data encoded using XML. In one embodiment, the client technology may include Objective-C, C, Java, Javascript, and AJAX depending upon the client platform.

### Other Technologies

An example embodiment may be implemented as a dynamic interface and use a set of tools consistent with this platform. In one embodiment, the server technology may include Tomcat and utilize custom Java servlets which interface with a MYSQL database. In one embodiment, the communication protocol used for client-server communication may be XML. XML may be transformed on the client side by XSL documents. The interface itself may use AJAX to dynamically load content into the interface without refreshing.

### Modules, Components, and Logic

Certain embodiments are described herein as including logic or a number of modules, components or mechanisms. A module, logic, component or mechanism (hereinafter collectively referred to as a “module”) may be a tangible unit capable of performing certain operations and is configured or arranged in a certain manner. In example embodiments, one or more computer systems (e.g., a standalone, client or server computer system) or one or more components of a computer system (e.g., a processor or a group of processors) may be configured by software (e.g., an application or application portion) as a “module” that operates to perform certain operations as described herein.

In various embodiments, a “module” may be implemented mechanically or electronically. For example, a module may comprise dedicated circuitry or logic that is permanently configured (e.g., within a special-purpose processor) to perform certain operations. A module may also comprise programmable logic or circuitry (e.g., as encompassed within a general-purpose processor or other programmable processor) that is temporarily configured by software to perform certain operations. It will be appreciated that the decision to implement a module mechanically, in the dedicated and permanently configured circuitry, or in temporarily configured circuitry (e.g., configured by software) may be driven by cost and time considerations.

Accordingly, the term “module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which modules or components are temporarily configured (e.g., programmed), each of the modules or components need not be configured or instantiated at any one instance in time. For example, where the modules or components comprise a general-purpose processor configured using software, the general-purpose processor may be configured as respective different modules at different times. Software may accordingly configure the processor to constitute a particular module at one instance of time and to constitute a different module at a different instance of time.

Modules can provide information to, and receive information from, other modules. Accordingly, the described modules may be regarded as being communicatively coupled. Where multiple of such modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation, and store the output of that operation in a memory device to which it is communicatively coupled. A further module may then, at a later time, access the memory device to retrieve and process the stored output. Modules may also initiate communications with input or output devices, and can operate on a resource (e.g., a collection of information).

Thus, methods and systems to provide services to a mobile device have been described. Although the present subject matter has been described with reference to specific exemplary embodiments, it will be evident that various modifications and changes may be made to these embodiments without departing from the broader spirit and scope of the subject matter. Accordingly, the specification and drawings are to be regarded in an illustrative rather than a restrictive sense.

1. A computer implemented method for providing supplemental services to a mobile device, the method comprising:
utilizing one or more processors to execute instructions stored on a computer-readable medium, the instructions causing the computer to perform:
receiving a request from a supplemental service library that is embedded in a client application program in a mobile device, the supplemental service library being a standard software component that is included in the client application program, the client application program being distributed over a network and stored on the mobile device;
identifying a supplemental service from a plurality of supplemental services based on the request; and
communicating a response to the mobile device responsive to receiving the request.

2. The computer implemented method of claim 1, wherein the supplemental service library includes a user interface module.

3. The computer implemented method of claim 1, further including communicating a notice to the mobile device via a notification server.

4. The computer implemented method of claim 1, further including:
receiving an advertisement from an advertisement server prior to the receiving the request; and
storing the advertisement on a data storage device prior to the receiving the request, and wherein the communicating the response includes retrieving the advertisement from a data storage device and communicating an advertisement response information that includes the advertisement to a user interface module that is included in the supplemental service library on the mobile device.

5. The computer implemented method of claim 4, wherein the communicating the response includes communicating advertisement retrieval information to a user interface module that is included in the supplemental service library on the mobile device.

6. The computer implemented method of claim 1, wherein the identifying of the supplemental service further includes identifying the client application program from a plurality of client application programs based on a client application program identifier that is received in the request and wherein the identifying of the supplemental service further includes identifying the mobile device from a plurality of mobile devices based on a mobile device identifier that is received in the request and wherein the identifying of the supplemental service further includes automatically identifying a user of the mobile device based on the mobile device identifier.

7. The computer implemented method of claim 1, further including:
associating the mobile device to a user that is actively utilizing the client application program;
identifying a plurality of other users who are friends of the user and are actively using the client application program; and
generating a friend listing interface that identifies the plurality of friends that are actively utilizing the client application program.

8. The computer implemented method of claim 7, wherein the friend listing interface further identifies a plurality of friends that are not actively utilizing the client application program.

9. The computer implemented method of claim 1, further including receiving diagnostic information from a second supplemental service module that is embedded in the client application program in the mobile device.

10. A system to provide supplemental services to a mobile device, the system comprising:
one or more processors;
a computer-readable medium with instructions stored thereon, the one or more processors interacting with the computer-readable medium to execute:
a receiving module to receive a request from a supplemental service library that is embedded in a client application program in a mobile device, the supplemental service library is a standard software component that is included in the client application program, the client application program distributed over a network and stored on the mobile device; and
a processing module to identify a supplemental service from a plurality of supplemental services based on the request and communicate a response to the mobile device responsive to receiving the request.

11. The system of claim 10, wherein the request includes a request for a user interface and wherein the user interface is selected from a group of user interfaces consisting of a home user interface, a user profile user interface, a user settings user interface, a message listing user interface, a message display user interface, a blog listing user interface, a topic listing user interface, and a friend listing user interface.

12. The system of claim 11, wherein the home user interface includes a user interface element that is selectable to display at least one announcement that is communicated to the mobile device from a publisher of the client application program.

13. The system of claim 11, wherein the user profile interface includes a picture associated with a user of the client application program.

14. The system of claim 11, wherein the user settings interface includes a user interface element that receives parameter information that is utilized to configure the client application program.

15. The system of claim 11, wherein the user settings interface includes user configurable settings to configure the client application program.

16. The system of claim 11, wherein the message listing interface includes a plurality of messages that have been respectively communicated to the mobile device from a plurality of mobile devices that store the client application program.

17. The system of claim 11, wherein the blog listing interface includes an input box that receives at least one keyword that is used to search a plurality of blogs that are accessible over a network.

18. The system of claim 11, wherein the topic listing interface includes an input box that receives at least one keyword that is used to search a plurality of topics that are respectively presented on a plurality of blogs that are accessible over a network.

19. The system of claim 11, wherein the message display user interface includes a message that is associated with a second client application program on the mobile device.

20. Using one or more processors to execute instructions retained in machine readable media to perform at least some of the following steps:
receiving a request from a supplemental service library that is embedded in a client application program in a mobile device, the supplemental service library being a standard software component that is included in the client application program, the client application program being distributed over a network and stored on the mobile device;
identifying a supplemental service from a plurality of supplemental services based on the request; and
communicating a response to the mobile device responsive to receiving the request.

21. A computer implemented method for providing supplemental services to a mobile device, the method comprising:
utilizing one or more processors to execute instructions stored on a computer-readable medium, the instructions causing the computer to perform:
receiving a request from a supplemental service library in a mobile device that receives the request from a stand-alone client application program in the mobile device, the supplemental service library being a standard software component that is utilized by the stand-alone client application program, the supplemental service library and the stand-alone client application program being independently distributed over a network and stored on the mobile device;
identifying a supplemental service from a plurality of supplemental services based on the request; and
communicating a response to the mobile device responsive to receiving the request.

22. The computer implemented method of claim 21, wherein the supplemental service library is embedded in a supplemental service program that executes as a stand-alone program on the mobile device.

23. The computer implemented method of claim 21, wherein the supplemental service library is embedded in a thin client program that executes in conjunction with a web browser that executes on the mobile device.

24. A system to provide supplemental services to a mobile device, the system comprising:
one or more processors;
a computer-readable medium with instructions stored thereon, the one or more processors interacting with the computer-readable medium to execute:
a receiving module to receive a request from a supplemental service library in a mobile device that receives the request from a stand-alone client application program in the mobile device, the supplemental service library being a standard software component that is utilized by the stand-alone client application program, the supplemental service library and the stand-alone client application program are independently distributed over a network and stored on the mobile device; and
a processing module to identify a supplemental service from a plurality of supplemental services based on the request and to communicate a response to the mobile device responsive to receipt of the request.

25. Using one or more processors to execute instructions retained in machine readable media to perform at least some of the following steps:
receiving a request from a supplemental service library that is embedded in a client application program in a mobile device, the supplemental service library being a standard software component that is built into the client application program, the client application program being distributed over a network and stored on the mobile device;
identifying a supplemental service from a plurality of supplemental services based on the request; and
communicating a response to the mobile device responsive to receiving the request.

26. A plurality of supplemental service interfaces stored on a computer readable medium for execution on a mobile device in conjunction with a supplemental service library, the plurality of supplemental service interfaces are utilized to provide supplemental service for a client application program on the mobile device, the plurality of supplemental service interfaces comprising:
a first interface that receives a request from the client application program; and
a second interface that communicates the request to a supplemental service server, the request including a mobile device identifier that identifies the mobile device from a plurality of mobile devices and a client application program identifier that identifies the client application program from a plurality of client application programs.

27. The plurality of supplemental service interfaces of claim 26, wherein the supplemental service library is embedded in the client application program.

28. The plurality of supplemental service interfaces of claim 26, wherein the second interface receives a selection of a user interface element that causes an exit and return to the client application program.

29. The plurality of supplemental service interfaces of claim 26, further including a third interface that receives a mobile device identifier.

30. The plurality of supplemental service interfaces of claim 29, wherein the third interface retrieves the mobile device identifier from the mobile device.

31. The plurality of supplemental service interfaces of claim 29, wherein the third interface appends the mobile device identifier to the request.

32. The plurality of supplemental service interfaces of claim 26, wherein the supplemental service library is embedded in a supplemental service program that communicates with the client application program.

33. The plurality of supplemental service interfaces of claim 26, wherein the request includes the client application program identifier.

34. The plurality of supplemental service interfaces of claim 26, wherein the supplemental service library is embedded in a thin client program that communicates with the client application program.

35. The plurality of supplemental service interfaces of claim 26, further including a fourth interface that receives diagnostic information from the client application program and communicates the diagnostic information to the supplemental service server.

36. The plurality of supplemental service interfaces of claim 26, wherein the second interface retrieves an advertisement from an advertisement server.

37. The plurality of supplemental service interfaces of claim 26, further including a fifth interface that receives a notice from a notification server and communicates the notice to the client application program.

38. The plurality of supplemental service interfaces of claim 26, wherein the second interface receives a second request from the client application program and further including a sixth interface that communicates the second request to the supplemental service server and further including a seventh interface that receives a second response from the supplemental service server and communicates the second response to the client application program.
